(19) United States
(12) Patent Application Publication
(10) Pub. No.: US 2024/0318964 A1
(43) Pub. Date: Sep. 26, 2024

(54) ENHANCED NAVIGATION, LOCALIZATION, AND PATH PLANNING FOR AUTONOMOUS ROBOTS

(71) Applicant: Intel Corporation, Santa Clara, CA (US)

(72) Inventors: Peter NOEST, Munich (DE); Klaus UHL, Karlsruhe (DE); Mirela Ecaterina STOICA, Ottobrunn (DE)

(21) Appl. No.: 18/393,728

(22) Filed: Dec. 22, 2023

(30) Foreign Application Priority Data
Mar. 24, 2023 (DE) 10 2023 107 422.9

(51) Int. Cl. G01C 21/34; B25J 5/00; B25J 9/16

(52) U.S. Cl. CPC G01C 21/3407; B25J 5/007; B25J 9/1664

(57) ABSTRACT

Disclosed herein are devices, methods, and systems for navigating and positioning an autonomous robot within a map of an environment. The system may obtain an occupancy grid associated with the environment around the robot, wherein the occupancy grid includes grid points of potential destinations for the robot. The system may determine, for each grid point of the grid points of potential destinations, a weight for the grid point based on a distance to the grid point from a predefined reference point and based on a directional deviation to the grid point, where the directional deviation comprises an angular difference between a current heading of the robot and an angular direction from the reference point toward the grid point. The system may select, based on the weight, a target point from among the grid points and generate a movement instruction associated with moving the robot toward the target point.

### CROSS-REFERENCE TO RELATED APPLICATION(S)

This application claims priority to German Patent Application No. 10 2023 107 422.9 filed on Mar. 24, 2023, the contents of which are fully incorporated herein by reference.

### TECHNICAL FIELD

This disclosure relates generally to robots, and in particular to autonomous mobile robots (AMRs) that may use simultaneous localization and mapping (SLAM) techniques when autonomously exploring and moving about an environment.

### BACKGROUND

In order to safely move from one location to another location within an environment, an AMR typically requires an accurate map of the environment and an accurate indication of the AMR's current position with respect to the map. When the environment is unknown or constantly changing, the AMR might not have complete picture of the environment and may need to build the map itself, even while it is moving through the environment. At the same time, because the AMR is moving, it must simultaneously keep track of its position and align its position with the map. This dual process of mapping and localization may be referred to as simultaneous localization and mapping (“SLAM”). Typically, an AMR may use sensor data to scan the environment and to estimate the extent of the AMR's movements within the environment.

For example, a light detection and ranging (“LiDAR”) sensor may be used to measure distances to obstacles from the AMR, which distances may be translated onto a map of the area around the AMR. At the same time, motion sensors may be used to estimate the AMR's relative position on the map as it moves throughout the environment. However, sensors and the SLAM-based algorithms used to estimate the positions of objects and/or correlate the AMR's position to the map of the environment are not always perfect, and neither mapping nor localization may be determined with complete accuracy. As a result, the map data may become corrupted with incorrect object data and/or an incorrect position of the AMR, and the AMR may collide with an object, move very slowly through the environment, may make frequent and repetitive sensor scans, may take inefficient and/or duplicative routes through an environment, etc.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an example of a navigation and localization system for an autonomous robot;

FIG. 2 shows an example graph of a weighting function that may be applied based on directional deviation from the robot's trajectory and/or based on distance;

FIG. 3 shows an example occupancy grid of an environment being explored by an autonomous robot;

FIG. 4A shows an example occupancy grid of an environment being explored by an autonomous robot;

FIG. 4B shows an example occupancy grid of an environment being explored by an autonomous robot using raytracing;

FIG. 5 illustrates an example of a scenario where an autonomous robot may become trapped in a corridor and may benefit from a retreat operation;

FIG. 6A shows an example occupancy grid of an environment that has been explored by an autonomous robot;

FIG. 6B shows an example occupancy grid of an environment that has been explored using raytracing by an autonomous robot;

FIGS. 7-8 each depict examples of how inaccurate sensor data may cause iterative errors to a SLAM algorithm, causing phantom objects in the occupancy grid;

FIG. 9A depicts an example of how SLAM localization may differ from the ground truth, causing errors in a SLAM algorithm and phantom objects in the occupancy grid;

FIG. 9B depicts an example of how SLAM localization may match the ground truth, reducing errors in a SLAM algorithm and reducing phantom objects in the occupancy grid;

FIG. 10 illustrates an example of how, as a robot moves through the environment, an area of the environment scanned in a prior scan may overlap with a current scan of the environment;

FIG. 11 depicts an example of how predefined patterns/noise may be added to a scan of the environment;

FIG. 12 shows an example of how an error vector may be determined based on the difference between a reference position and a SLAM-based position;

FIG. 13 depicts an example of a move/scan loop of a navigation and localization system for an autonomous robot that may include a feed-forward combiner and/or an error vector checker;

FIGS. 14A-14B depict occupancy grids from a simulation of robot exploration using a conventional SLAM-based algorithm to map the environment;

FIGS. 15A-15B depict occupancy grids from a simulation of robot exploration using an improved SLAM-based algorithm to map the environment;

FIG. 16 shows an exemplary schematic drawing of a device for navigation and localization of a robot within an environment;

FIG. 17 depicts a schematic flow diagram of an exemplary method for navigation and localization of a robot within an environment;

FIG. 18 depicts a schematic flow diagram of an exemplary method for navigating a robot; and

FIG. 19 depicts a schematic flow diagram of an exemplary method for localization of a robot.

### DESCRIPTION

The following detailed description refers to the accompanying drawings that show, by way of illustration, exemplary details and features.

The word “exemplary” is used herein to mean “serving as an example, instance, or illustration.” Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in the form of a pointer. The term “data”, however, is not limited to the aforementioned examples and may take various forms and represent any information as understood in the art.

The terms “processor” or “controller” as, for example, used herein may be understood as any kind of technological entity (e.g., hardware, software, and/or a combination of both) that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, software, firmware, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as radio frequency (RF) transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both “direct” calculations via a mathematical expression/formula/relationship and ‘indirect’ calculations via lookup or hash tables and other array indexing or searching operations.

A “robot” may be understood to include any type of machine. By way of example, a robot may be a movable or stationary machine, which may have the ability to move relative to itself (e.g., movable arms, joints, tools, etc.) and/or to move relative to its environment (e.g., move from one location in an environment to another location of the environment). A robot should be understood to encompass any type of vehicle, such as an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, or a rocket, among others. Thus, references herein to “robot” or AMR should be understood to broadly encompass all of the above.

The term “autonomous” may be used in connection with the term “robot” or “mobile robot” to describe a robot that may operate, at least to some extent, without human intervention, control, and/or supervision. For example, an autonomous robot may make some or all navigation, movement, and/or repositioning decisions without human intervention. The term “autonomous” does not necessarily imply, however, that sensors, data, or other processing must be internal to (e.g., on-board) the robot, but rather, an autonomous robot may utilize internal systems or distributed systems, where at least part of the sensor information, processing, and other data may be received by the robot from external (e.g., off-board) sources, communicated from devices external to the robot (e.g., transmitted wirelessly from a device that is external to the robot).

As noted above, an autonomous robot may use sensors to scan the environment and to estimate the extent of its movements within the environment. However, sensors and the algorithms used to estimate the locations of objects and/or the position of the robot on a map of the environment usually include some amount of error, and neither mapping nor localization may be determined with complete accuracy. As a result, the map data may become, over time, corrupted with incorrect object data and/or an incorrect position of the robot on the map, and the robot may need to move very slowly, make frequent and repetitive sensor scans, take inefficient and/or duplicative routes, etc., in order to safely explore and navigate. In short, conventional exploration algorithms may be inefficient, may result in unsafe situations, may not consider how their determined exploration routes impact the quality of the map, may result in incorrect motion, and/or may cause the robot may become erratic, paralyzed, or confused because of an inability to locate any suitable paths.

In contrast to conventional autonomous robot exploration algorithms, the navigation and localization systems disclosed below may provide an improved way of determining exploration paths that may lead to more time-efficient, complete, and accurate mapping when the robot is operating autonomously (e.g., when using a SLAM-based algorithm). The disclosed navigation and localization systems may provide improved path selection that results in a high rate and efficiency of exploration of an environment, a higher accuracy of the resulting map of the environment, a shorter time needed to fully explore the environment, and a lower likelihood that the robot's movements will become erratic, paralyzed, or confused.

In addition, the navigation and localization systems disclosed below may provide a failure detection in the SLAM-based algorithm used during exploration, and may either reset the mapping/positioning of the SLAM algorithm (e.g., restart from scratch) or may revert the mapping/positioning data to a previous version that was sufficiently error free (e.g., satisfied a threshold for “good” data). In addition, the navigation and localization systems disclosed below may utilize previous scans of the environment in the SLAM algorithm by transforming the previous scans to be cast into the currently estimated position, where any overlap of the transformed previous scan with the current scan may be used to enrich the SLAM algorithm.

In general, an AMR may use a SLAM algorithm to update its position and build an accurate map of the environment. Typically, a SLAM algorithm consists of multiple steps that includes a scan of the environment using a sensor such as a LiDAR, radar, camera, etc. Next, the scan is transformed to map coordinates (e.g., into an occupancy grid or occupancy map) so that objects detected by the scan may be accurately placed on the map and the AMR's position within the map coordinate system may be estimated. This may be accomplished by observing features in the environment and monitoring how they change on the map as the AMR moves about the environment. The movement of the robot may also be estimated by a planning system (e.g., travel along a planned trajectory at a particular velocity for a certain amount of time) or by other types of motion-based sensors (e.g., an odometer) to estimate the relative movement of the AMR (e.g., how far and in which direction the AMR has moved since its last position). By using the estimated movement and the current scan of the environment, the SLAM algorithm may maintain an estimated position of the AMR within a current map of the environment.

As should be appreciated, mapping and positioning may be for multiple dimensions (e.g., a two-dimensional (2D) space defined by a surface, a three-dimensional (3D) space defined by a volume, etc.) so that the mapping and positioning may be determined within any dimension in which the AMR may be moving. Thus, while the description herein may be with respect to 2D mapping/positioning, this is for simplicity of examples and is not meant to be limiting, and the navigation and localization systems disclosed below may be used with any number of dimensions.

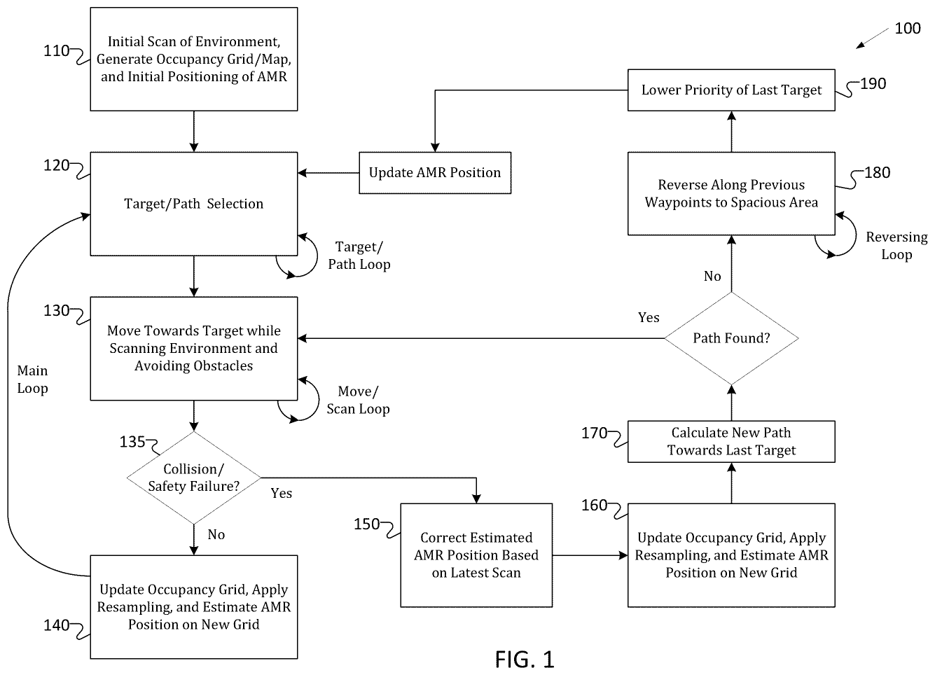

FIG. 1 shows an exemplary navigation and localization system 100 that may be or be part of a SLAM algorithm, where the goal of such a system is to allow for safe, autonomous movement of an AMR within an unknown and/or changing environment. Thus, the AMR may need to, while moving through the environment, continuously and accurately map the environment and localize itself on the map in order to move safely through the environment. In 110, the AMR may obtain a scan of the environment in order to generate an initial map of the environment and estimate an initial position the AMR on the map of the environment. As used herein the term “scan” may be used to refer to a collection of current sensor data that is indicative of the environment (e.g., a sensor observation). For example, a “scan” may refer to a collection of LiDAR data whose laser(s) have swept the environment and returned a point cloud of data that contains detected points, each associated with a distance and an angle to the given point, where the LiDAR point cloud may be transformed into map coordinates to build a grid of occupied and unoccupied spaces (e.g., an occupancy grid/map). A scan may also refer to any other sensor data such as an imaging camera that has imaged the environment around the AMR (e.g., in an image or series of images), where such imaged data may be processed for object detection and translated into an occupancy grid of the environment around the robot.

As should be appreciated, any type of sensor data may be used to generate maps of the environment, from which the system may identify occupied and unoccupied map spaces and position the AMR within the map. As should also be appreciated, a map of the environment may be subdivided into any number, type, and shape of subregions, where the dimensions of the subregion may reflect the resolution with which occupancy may be determined. For example, if large subregions are used, where occupancy is determined for the entire subregion, the resolution may be low and only coarsely determined. If the subregions are smaller, the resolution may higher be more finely determined. For simplicity of description, as used herein, a map of the environment may be referred to as an occupancy “grid” with the subdivisions referred to as “grid points,” where a “grid point” is the subregion into which the map has been subdivided. It should be appreciated that subdivision need not be grid-shaped and that the grid points map may be of any size and dimension.

After an initial mapping and positioning, the navigation and localization system 100 may select, at target/path selection 120, a target destination on the map and a planned path for arriving at the destination. For example, the target destination may be a waypoint that is part of a larger task, goal, or strategy, such as to fully explore the environment, safely traverse a room from an entrance to an exit, sanitize all the surfaces in a room, move an object from one part of the room to another part of the room, etc. When the goal is exploration, for example, target/path selection 120 may select a series of target destinations so as to quickly and efficiently identify all of the traversable space within the environment (e.g., categorize each grid point on the map as being occupied or unoccupied). The target/path selection 120 may, for example, build a set of potential targets based on various criteria. For example, the set of potential targets may be grid points that are close to a “frontier,” where a frontier is the apparent boundary between already-explored grid point(s) and unexplored grid point(s). In addition, the target/path selection 120 may prioritize the potential targets in the set based on whether the potential target satisfies any number of criterion, including for example, based on whether the potential target is a predefined distance from the frontier and/or a predefined distance from an occupied grid point. As should be appreciated, the predefined distance may be the Euclidean distance (e.g., the distance between two points, assuming a direct path or “as the crow flies”) or the predefined distance may be the path distance (e.g., the distance needed to actually travel the path from the start to the end). In addition, the target/path selection 120 may determine a path to each of the potential targets and prioritize the potential target based on whether a suitable path exists (e.g., is a “reachable” target) and/or on the type, timing, safety, length, etc. of the path. If a potential target is not reachable, it may be removed from the list of potential targets. In addition, the target/path selection 120 may prioritize the potential targets based on a directional deviation to the potential target from a reference location (e.g., the angular difference between the current heading of the AMR from its estimated location and an angle to the potential target from the AMR's estimated location).

As should also be appreciated, the target/path selection 120 may also use such criteria to segregate, distinguish, prioritize, and/or select a target for inclusion in the set of potential targets. For example, the target/path selection 120 may segregate the set of potential targets into different groups that have different categorizations. One such example is a group of “simple” targets and group of “preferred targets,” where the simple targets may be prioritized based on different criteria as compared to the criteria used to prioritize the preferred targets. Such groupings may allow for a fail-safe or fallback scheme, where if there are no suitable targets in the set of preferred targets, the target/path selection 120 may fall back to one of the simple targets, and/or reset the entire algorithm if no suitable target is found within the set of simple targets.

Target/path selection 120 may use weights to prioritize the potential targets. For example, a given criterion may be associated with a weight (e.g., a numerical value, a range of values, or function(s) that represent whether and/or to what extent the criterion is met) that the target/path selection 120 may use to influence the potential target's priority. Using path distance as an example, target/path selection 120 may prioritize shorter paths over longer paths by assigning a lower weight if the path is longer and a higher weight if the path is shorter (e.g., the weight could be inversely proportional to the length of the path). Using directional deviation as an example, target/path selection 120 may prioritize targets that are aligned with the current heading of the AMR over targets in other directions by assigning a higher weight if the directional deviation is low and a lower weight if the directional deviation is high (e.g., the weight could be inversely proportional to the directional deviation of the potential target). Then, the target/path selection 120 may add together, for each of the potential targets, the weight assigned for each criterion, where the potential target with the highest total weight may correspond to the target with the highest priority. Grid points deemed unreachable may be set to a weight of zero.

As should be understood, one criterion may be given higher priority over another criterion in any manner. For example, different weights may be applied to different criterion (and therefore a weight applied to the weight) and/or the weights associated with each criterion may be have different magnitudes/ranges relative to the weights of other criteria. For example, if direction deviation is to be prioritized over distance, the weights associated with directional deviation may be multiplied by a higher criterion weighting factor (e.g., its weights multiplied by 2) as compared to the criterion weighting factor for distance (e.g., its weights multiplied by 1). Or, if directional deviation is to be prioritized over distance, the weights associated with directional deviation may be larger in magnitude than those associated with distance.

As should also be understood, the criteria may be interdependent such that the weights for a given criteria may depend on other criteria. In other words, the weighting may be based on other variable(s)/function(s). Using directional deviation as an example, the directional deviation may be assigned a higher weight if the distance to the potential target is within the sensor range (e.g., the reliable measurement distance of the sensor), whereas directional deviations outside the sensor range may be assigned a lower weight. In such a scenario, directional deviation may have a larger influence on prioritization if the potential target is within the sensor range but may have less influence on prioritization if the potential target is outside the sensor range.

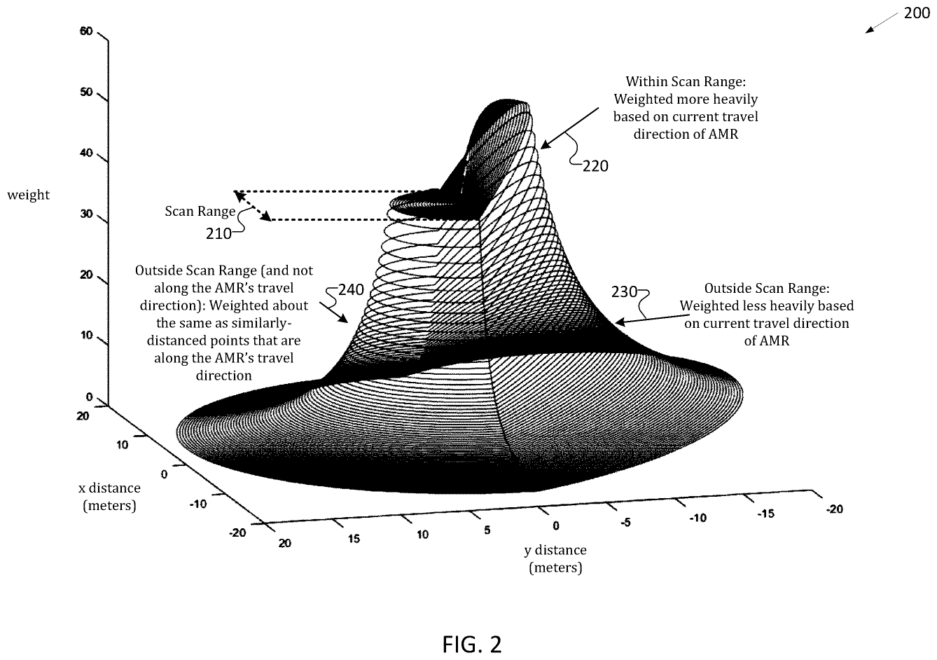

An example of such interdependent weighting of directional deviation and distance (e.g., actual path length) is shown in graph 200 of FIG. 2. The weight assigned to a given potential target is plotted on the y (vertical) axis of graph 200 as a function of the target's x path length (in meters) and the y path length (in meters) relative to the reference position (e.g., from the estimated current position and taking into account the heading of the AMR). In this example, the AMR is heading in the y direction, the scan range is shown by measurement 210, and the target/path selection 120 prioritizes based on path length and directional deviation of the target, where directional deviation provides higher influence on the target's priority when the target is within the scan range but provides a lower influence when the target is outside the scan range. This interdependency may be seen in graph 200, where there is a sharp increase in the weighting in region 220 because it is both within the scan range (measurement 210) and along the same direction as the AMR's current heading. Outside the scan range, however, the directional deviation has less influence over the weighting. This can be seen in region 230, for example, where targets in the same angular direction as the AMR's heading are not as heavily influenced by the angular direction as those within the scan range and thus have about the same weight as similarly distanced points in other angular directions (e.g., in region 240). Thus, for targets that are within the scan range, they are weighted more heavily if they have a lower directional deviation (e.g., the angular direction from the current position to the target is close to the current heading of the AMR) and directional deviation has less of an impact to the weighting if the target is outside the scan range. As should be appreciated, the weighting relationship shown in FIG. 2 is merely exemplary and any type of relationship may be used to arrive at a weight, dependent on any number or type of variable(s), function(s), and/or interdependent criteria.

An example of how the target/path selection 120 may select a target based on, for example, a weighting that depends on the angular distance to the target is shown below:

```
frontier_distance=path_lenghts_bestFrontier(i2); %routed
distance or Euclidean (preferred is routed)
if isnan(frontier_distance)
  %remove frontier if there is no path to frontier from
curr position
  bestFrontier_lowres(i2,:)=[ ];
  path_lenghts_bestFrontier(i2)=[ ];
else
  delta=bestFrontier_lowres(i2,1:2)−curr_pos_lowres(1:2);
  delta=delta/norm(delta)*frontier_distance;
  %note, scalar product is larger (and positive value)
when delta
  %vector is pointing into direction of the pose angle
direction
  if(frontier_distance<lidarRange)
    frontier_pose_scalar_product=...
    max(delta/(frontier_distance+lidarRange)\hat{ }2.5...
  *[cos(curr_pos_lowres(3));...
  sin(curr_pos_lowres(3))],0)+1/...
  (lidarRange)\hat{ }2;
  else
    frontier_pose_scalar_product=...
  1/(frontier_distance)\hat{ }2+...
  max(delta/(frontier_distance+lidarRange)\hat{ }2.5...
  *[cos(curr_pos_lowres(3));sin(curr_pos_lowres(3))],0)
  end
bestFrontier_lowres(i2,3)=frontier_pose_scalar_product;
%=weight
i2=i2+1;
end
```

As should be appreciated, the pseudocode above is merely exemplary and any type of relationship may be coded to arrive at a weight, dependent on any number or type of variable(s), function(s), and/or interdependent criteria.

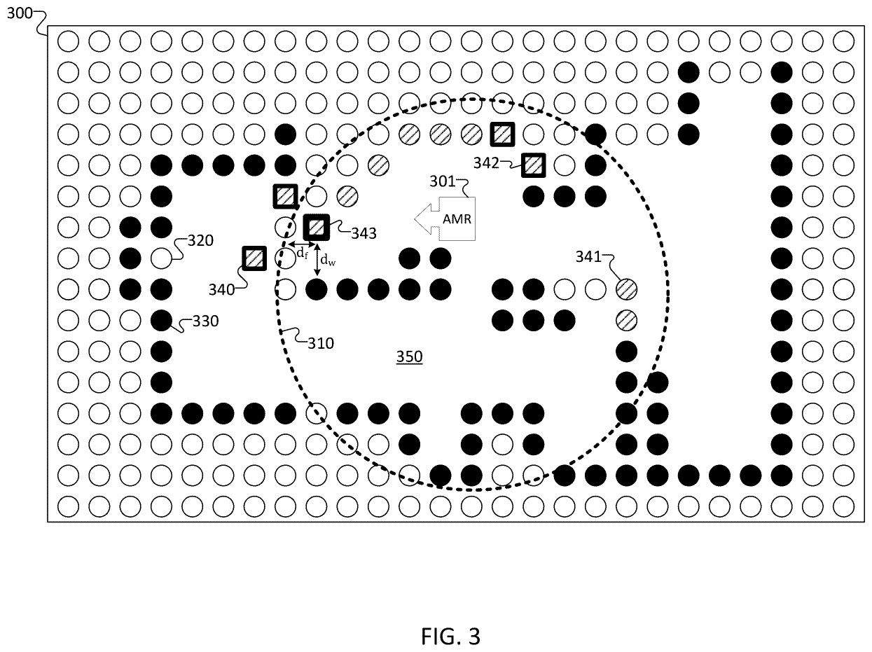

An example of weighted target selection (e.g., by target/path selection 120) will be discussed with reference to FIG. 3 FIG. 3 shows an example of an occupancy grid 300 (e.g., a current map of the environment), where unexplored grid points are represented by unfilled circles (e.g., one example is grid point 320), occupied grid points are represented by solid-filled circles (e.g., one example is grid point 330), and traversable space is represented by an absence of a shape (e.g., open region 350). AMR 301 is currently traveling from right to left, as indicated by its arrow, in the environment represented by occupancy grid 300 and it is selecting its next target (e.g., by target/path selection 120) using its (estimated) current position as a reference point for evaluating potential targets. The sensor range of AMR 301 is shown by circle 310. Shaded grid points represent unexplored grid points within the set of potential targets, were circle-shaped, shaded grid points represent simple targets and square-shaped, shaded grid points represent preferred targets. The AMR may have selected the potential targets based on the grid point being a predefined threshold distance from a frontier (d_{f}), being a predefined threshold distance to a nearby wall/occupied space (d_{w}), or some other inclusion criterion. Other unexplored grid points may have been excluded from the set of potential targets because of a removal criterion, such as lack of a suitable path to the grid point, the grid point being too close/far from a frontier, the grid point being too close/far from a wall/occupied space, or some other removal criterion.

In the example scenario shown in FIG. 3 and using the exemplary weighting and/or pseudocode discussed above with respect to FIG. 2, for example, where the potential targets with a lower directional deviation are weighted higher than those targets with a higher directional deviation, and where nearer potential targets are weighted higher than targets farther away, AMR 301 has selected grid point 343 as its target. With respect to grid point 342, for example, although it is about the same travel distance from AMR 301 as is grid point 343, grid point 343 received a higher weight because it has a lower directional deviation (e.g., it is in the same travel direction as the current travel direction of AMR 201).

Returning to FIG. 1, once a target and associated path has been selected by target/path selection 120, the AMR may be moving, as part of a move/scan loop 130, towards the selected target while at the same time scanning the environment in order to safely navigate and avoid obstacles. The movement and scanning may be understood as a continuous loop that is supported by the SLAM algorithm, where as the AMR moves toward the target, it continues to scan the environment while updating its map/position. The AMR may perform collision checking, in 135, based on the new scan, and if no collision or other error has been detected, update, in 140, its map and its estimated position within the updated map, correcting its course if necessary. If a collision or other error has been detected, the navigation and localization system 100, may in 150, apply an error correction to update the estimated position of the AMR based on the most recent scan data. Once a new (corrected) estimated position has been determined, the navigation and localization system 100 may update, in 160, the occupancy grid, apply a resampling, and update the AMR's estimated position within the updated occupancy grid.

As part of the map update in 140 or the map update in 160, the navigation and localization system 100 may apply a resampling of the map data. In this case, resampling means to adjust the grid size or resolution of the map so that there are more grid points (e.g., smaller subdivisions and a finer resolution; up-sampling) or fewer grid points (e.g., larger subdivisions and a coarser resolution; down-sampling). It may be advantageous, for example, to down-sample a finer set of grid points into a much coarser set of grid points in order to reduce the number of artifacts; reduce the computational effort needed to evaluate occupancy, plan paths, measure distances, etc.; and/or to avoid entering into unsafe (e.g., narrow) spaces. In addition, the navigation and localization system 100 may apply a raytracing to the map data. Raytracing may be applied to the current scan data in order to clean up errant artifacts from the scan that may appear as occupied space. The result is that the grid points identified by the scan as unexplored may be recast as explored, unoccupied space, which means that there is significantly more traversable area for the navigation and localization system 100 to use during the next iteration of the target/path selection 120. Raytracing may be particularly beneficial in the direction of the current heading of the AMR and within the sensor range.

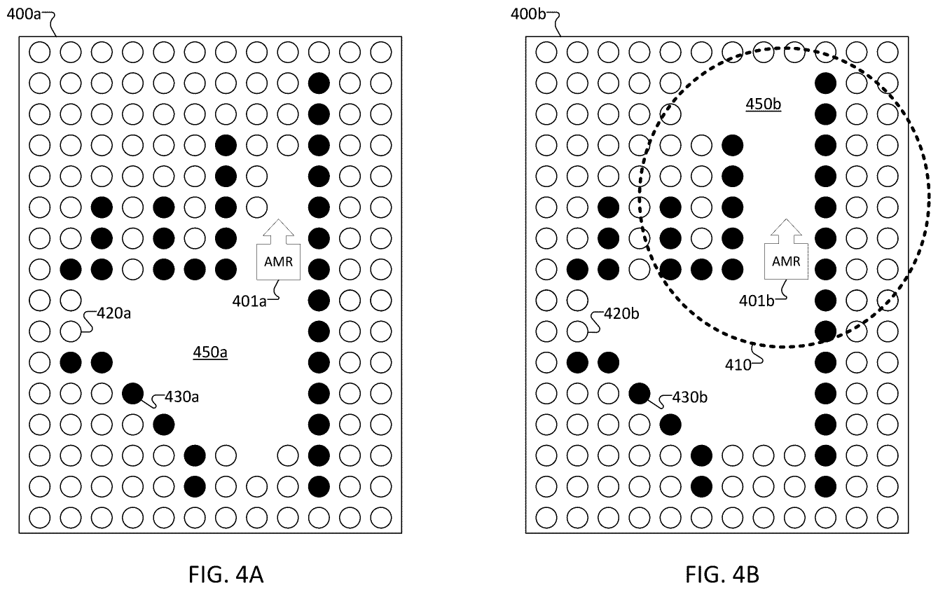

An example of the benefit of raytracing can be seen by comparing FIGS. 4A and 4B. FIG. 4A shows an occupancy grid 400a where AMR 401a is traveling in the direction of the arrow, upward along a corridor. In occupancy grid 400a, unexplored grid points are represented by unfilled circles (e.g., one example is grid point 420a), occupied grid points are represented by solid-filled circles (e.g., one example is grid point 430a), and traversable space is represented by an absence of a shape (e.g., open region 450a). In occupancy grid 400b, unexplored grid points are represented by unfilled circles (e.g., one example is grid point 420b), occupied grid points are represented by solid-filled circles (e.g., one example is grid point 430b), and traversable space is represented by an absence of a shape (e.g., open region 450b). As seen in FIG. 4A, the recent scan data contained artifacts/errors, such that the space immediately in front of AMR 401a has been classified as unexplored space. In FIG. 4B, raytracing has been used to clean up the scan data. As a result, the space immediately in front of AMR 401b, and within sensor range 410, has been classified as traversable space.

Returning to FIG. 1 and the collision checking at 135, to the extent a collision or other error was detected (at 135), the navigation and localization system 100 may determine (in 170) a new path towards the last target after correcting the estimated position of the AMR (in 150) and after updating the map (in 160). If a new path to the last target is found, the new path may be provided to the move/scan loop 130 to continue moving and scanning along the new path towards the last target. If no suitable path is found, the navigation and localization system 100 may perform a retreat operation (at 180) from the last target back to and select a new target (at target/path selection 120). Before searching for a new target, the navigation and localization system 100 may lower the priority of the last target so that it has a lower likelihood of being selected by the target/path selection 120 as the next target.

In order to perform the retreat operation, the AMR may follow the waypoints it used to arrive at the current position in reverse until a safe retreat condition is met. During the retreat, the AMR may temporarily disable or reduce the safety margins of its sensor-based navigation a simply reverse along the set of previously known-good waypoints until the safe retreat condition is met. For example, the safe retreat condition (e.g. criterion) may be based on free space, where the condition may be satisfied once the AMR is located in an area with a sufficiently large amount of nearby traversable space. Or, the retreat condition may be based on distance traveled, number of waypoints, travel time, etc. After the retreat condition is met, the navigation and localization system 100 may update the AMRs current position on the map and return to target/path selection 120 based on the updated position.

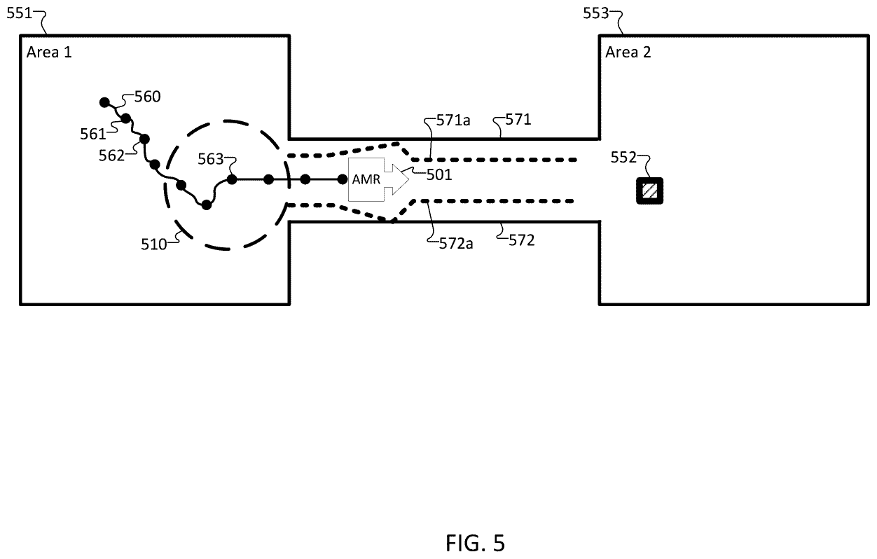

An example of a retreat operation is described with respect to FIG. 5 in more detail below. FIG. 5 shows two walled areas, walled area 551 and walled area 553, that are connected by a corridor defined by wall 571 and wall 572. While heading toward target 552, AMR 501 entered the corridor from wall area 551 toward walled area 553. After entering the corridor, the sensor scans became corrupted/noisy such that the sensor-perceived walls (represented by sensed wall 571a and sensed wall 572a) made the corridor appear narrower than originally perceived by the sensors. This may occur due to the dynamic nature of the map as it is updated during exploration, where a narrow pathway (e.g. corridor) appears wide enough in the map to be traversed by AMR 501 at one point in time, but while AMR 501 traverses this pathway, it appears too narrow for AMR 501 to continue. As a result, AMR 501 may not be able to move in any direction because all directions are perceived by the sensor system as being too narrow for AMR 501 to traverse.

In order to resolve this situation, the navigation and localization system 100 may instruct AMR 501 to follow—in reverse—the waypoints it used to arrive at its current location. As shown in FIG. 5, AMR 501 followed path 560 to arrive at its current location, traversing the waypoints identified by the black dots (e.g., examples of which are labeled as waypoints 561, 562 and 563). The reverse operation may involve AMR 501 reversing along the waypoints on path 560 until a safe retreat criterion is met. As one example, the safe retreat criterion may be a waypoint with a threshold amount of traversable space around AMR 501. As shown in FIG. 5, waypoint 563 satisfies the criterion, where waypoint 563 has a minimum amount of free space around it, as shown with respect to threshold 510. Thus, AMR 501 may reverse from its current location along the waypoints of path 560 until it reaches waypoint 563. During the retreat, the AMR may temporarily disable or reduce the safety margins of its sensor-based navigation and simply move from previous waypoint to previous waypoint (e.g., without regard or with less regard to sensor data so that the retreat is successful). Once the safe retreat condition is met, AMR 501 may resume target/path selection. Before selecting a new target, the navigation and localization system 100 may lower the priority/weighting associated with target 552 (e.g., the target that the AMR 501 was not able to reach because of the narrow corridor) so that it has a lower likelihood of being selected by the target/path selection 120 as the next target. As should be understood, the navigation and localization system 100 may also categorize target 552 as “unreachable” (e.g., by setting its priority/weighting to zero) but this may not be necessary, because the AMR 501 may later find an alternative route to target 522 (e.g., without needing to navigate through the problematic corridor).

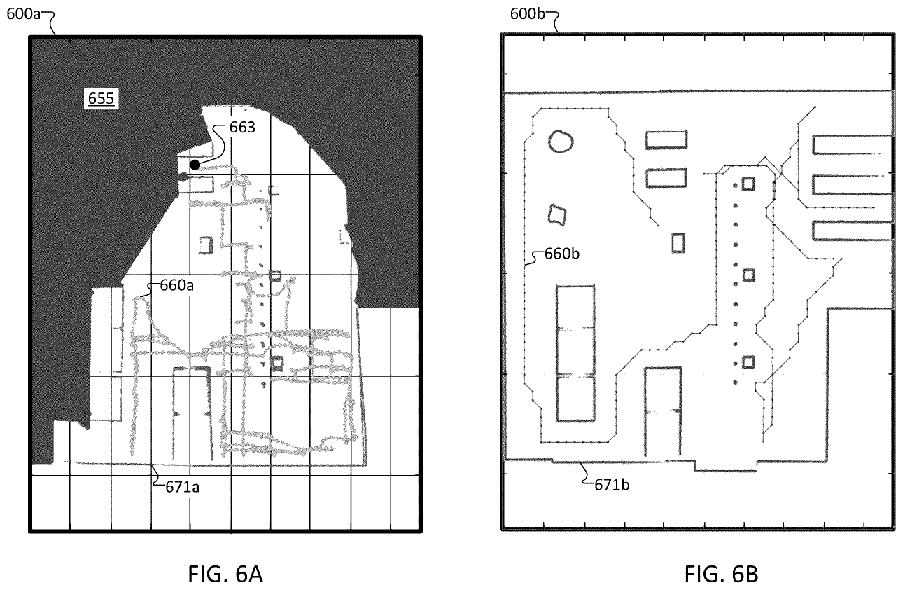

FIGS. 6A and 6B show exemplary occupancy grids formed from an AMR's exploration of a room. FIG. 6A provides an example occupancy grid of how the AMR may explore the room using a conventional SLAM algorithm whereas FIG. 6B provides an example occupancy grid of how the AMR may explore the room using the improvements disclosed herein. In FIG. 6A, the AMR has traveled along exploration path 660a, defined by the series of cyan waypoints. The AMR has mapped only a portion of the room to identify traversable space (e.g., white, unmarked spaces) and obstacles (e.g., objects/walls outlined by magenta grid points as indicated at 671a). As can be seen, the AMR moved back and forth within the same general area multiple times (e.g., in the lower left area of occupancy grid 600a) and eventually got stuck in a narrow corridor at waypoint 663. Thus, not only was the path selection inefficient, but the AMR also left unexplored nearly half of the occupancy grid 600a, as indicated by red area 655.

By contrast, as the occupancy grid of FIG. 6B shows, the AMR was able to more efficiently explore the room using the improvements disclosed herein, such as with improved target/path selection, grid resampling, depth raytracing, and waypoint reversal. As shown in FIG. 6B, the AMR traveled along a more efficient exploration path 660b as compared to exploration path 660a of FIG. 6A, with less overlap of already-traversed spaces. The AMR was able to map, without getting stuck in any of the narrow corridors, nearly the complete room, as shown by the objects/walls outlined by magenta grid points as indicated at 671b.

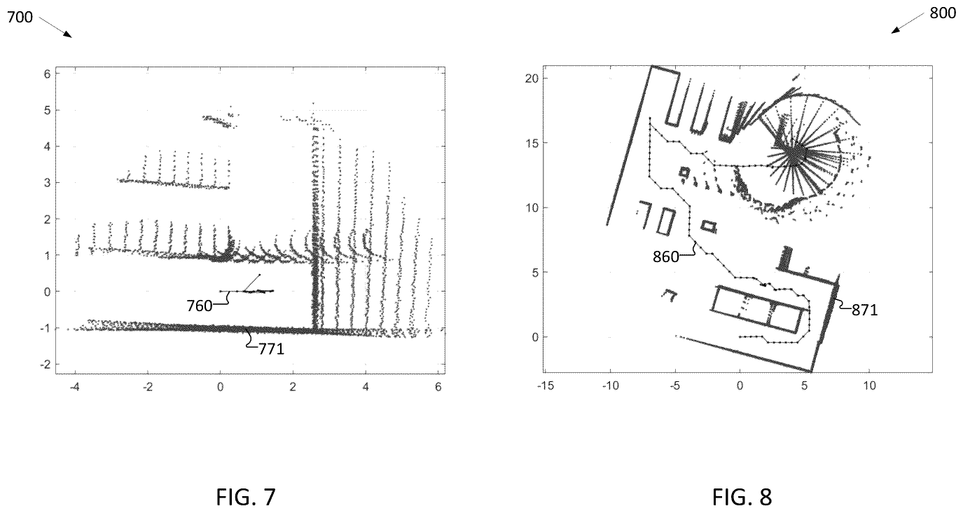

As noted above with respect to the FIG. 5, sensor data may be or become inaccurate, especially in areas difficult to scan. If inaccurate sensor data is fed into a SLAM algorithm, the error may be compounded from iteration to iteration as the AMR moves because inaccurate map data may lead to inaccurate localization of the AMR, which in turn leads to further corruption of the map data and further corruption of the AMR's location. Examples of how inaccurate sensor data may cause iterative errors to a SLAM algorithm are shown in occupancy grid 700 of FIG. 7 and occupancy grid 800 of FIG. 8. In FIG. 7, inaccurate sensor data of two walls has caused several phantoms of the walls to appear at different locations on the map, leading to repeated vertical lines along the horizontal axis (shown by the objects/walls outlined by magenta grid points as indicated at 771) at incorrect locations as the AMR moves (shown by exploration path 760 in blue). Another example is shown in FIG. 8, where several phantom walls are repeated in a wheel and spoke fashion (upper right corner of occupancy grid 800) as the AMR navigates around a post (e.g., along exploration path 860 in blue).

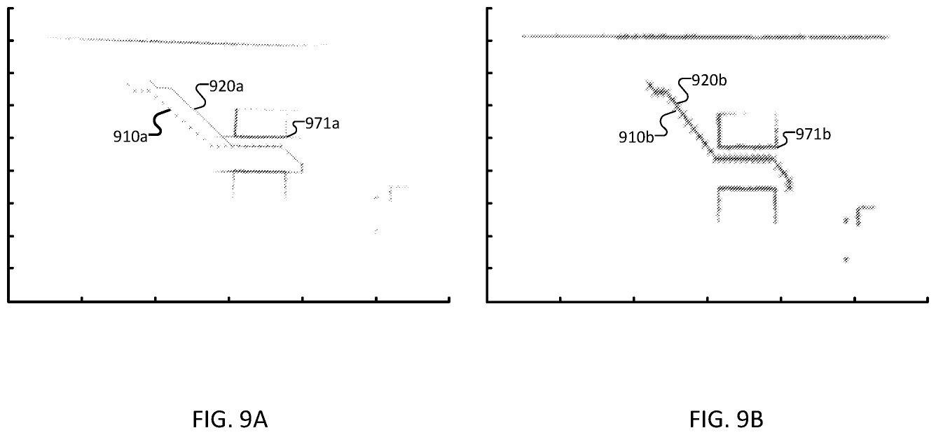

As noted earlier, such errors may be due to a discrepancy between the SLAM-estimated position of the AMR and its actual position (e.g., the ground-truth of the AMR). FIG. 9A, for example, shows how such a discrepancy may lead to inaccurate mapping, where the SLAM-estimated position is shown along path 920a and the ground truth of the trajectory is indicated by the series of x-points of path 910a. Because the SLAM-estimated position does not match the actual position, the spaces identified as occupied in the occupancy grid (shown by the objects/walls outlined by magenta grid points as indicated at 971a) may be inaccurate (shown by the phantom lines at the intersections of vertical/horizontal walls). In FIG. 9B, the SLAM-estimated position (e.g., along path 920b) matches the ground truth (e.g., indicated by the series of slashes along path 910b) of the trajectory, and the spaces identified as occupied in the occupancy grid (shown by the objects/walls outlined by magenta grid points as indicated at 971b) become clearer and more accurate, without phantom lines.

In order to reduce the impact of inaccurate sensor data on the SLAM algorithm, the navigation and localization system (e.g., navigation and localization system 100) may utilize a feed-forward combiner and/or an error vector checker, each of which are discussed in more detail below. The feed-forward combiner, for example, may enhance the sensor data fed into the SLAM algorithm by combining a current scan of the environment with prior scan(s) of the environment that have been position-adjusted forward to the same time/position of the current scan. The feed-forward combiner may also inject synthetic patterns/noise into the scans (e.g., as a simulated key point) so that the SLAM algorithm may more easily associate object features in consecutive scans.

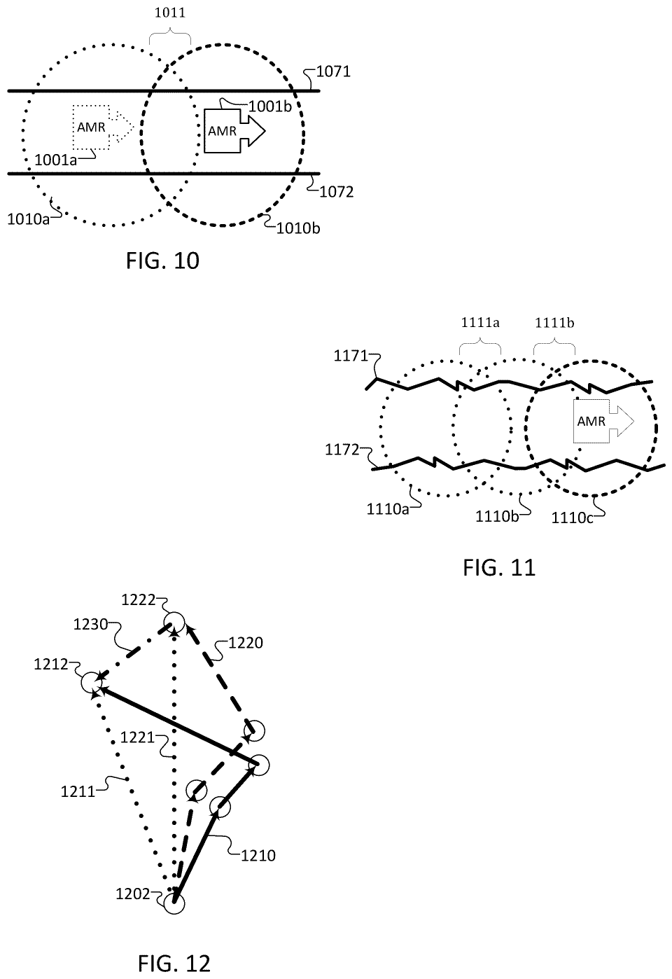

FIG. 10 shows an example of a scenario in which the feed-forward combiner may be used, where an AMR is moving left to right along a corridor defined by wall 1071 and wall 1072. At a first position 1001a, the AMR may scan the environment with a sensor range 1010a. As the AMR uses SLAM to move from left to right through the corridor, the AMR may scan the environment at a second position 1001b at a later time, where the sensor range is outlined by sensor range 1010b. For the region 1011 where there is overlapping sensor data, this data may be transformed to a coordinate system that is based on the current position 1001b of the AMR. The transformation may be based on, for example, the estimated movement vector between the first position 1001a and the second position 1001b. The estimated movement vector may be based on a change in position (e.g., determined from a motion sensor, odometer, tachometer, etc.) or based on the planned movement (e.g., determined from a planned speed along a planned path for a travel time, etc.) between the first position 1001a and the second position 1001b. Further the planned/estimated movement may be based on whether the movement includes at least one translation motion (e.g., whether there is a movement/motion in the x-direction or y-direction over a certain Euclidian distance, as opposed to only in the z-direction).

Due to noisy key points and unique object deviations (passed corners, roughness of walls), the inclusion of sensor data from prior positions that have been transformed to the current location may help the SLAM algorithm match the new sensor data to the correct location in the map, rather than associating the new sensor data with an incorrect key point and therefore an incorrect location. This feed-forward combiner may therefore significantly improve the position estimate of the SLAM algorithm, especially in areas with poorly identifiable key-points or in areas that lack uniquely-identifiable objects. The improved identifiability of key points may be due to the known noise associated with a given key point, where this same noise pattern may be found in a subsequent frame. Then, the pose graph optimization of the SLAM algorithm may more accurately and/or more reliably align from the combined scan data the key point onto the accumulated SLAM map.

If the key point(s) has too little noise or an insufficient object deviation such that it may be hard to match the key point to a prior scan, the feed-forward combiner may inject artificial noise or an artificial pattern into the scans. The feed-forward combiner may inject noise based on the number of existing features and/or based on the directional uncertainty of current observations and previous observations, where the directional uncertainty may be checked in multiple directions for a weak alignment of observations. Thus, the navigation and localization system may selectively utilize the feed-forward combiner, using it in areas with ambiguous features and not using it areas where feature-rich observations are possible. As should be understood, the term “key point” may be any point of interest in a scan and may include synthetic points that have been injected as simulated noise in the scan. For a typical LiDAR scan, each individual point of the point cloud may be a key point. Of course, additional processing may be applied to the individual points of a scan to abstract them to different grouping levels such as an object like a wall, cabinet, corridor, etc. For a camera-based scan, the key points may be extracted from the raw image data using feature extraction (e.g., using a feature extractor such as ORB, SIFT, SURF, BRIEF, etc.).

FIG. 11 shows an example occupancy map, similar to the scenario of FIG. 10, where the feed-forward combiner has injected an artificial, known pattern into the featureless walls of the corridor. Thus, the otherwise featureless walls 1071 and 1072 of FIG. 10 have been enhanced in FIG. 11 with a known pattern to transform them into synthetic key points represented by patterned walls 1171 and 1172 that may be more easily associated from one scan the next as the AMR moves positions. Thus, the synthetic points of the injected pattern of the wall that falls within an overlapping region 1111a of scan range 1110a of a first scan and scan range 1110b of a second scan may be more easily associated to one another in the SLAM algorithm. Similarly, as the AMR continues to move, the injected pattern of the wall that falls within an overlapping region 1111b of scan range 1110b and scan range 1110c of a third scan may be more easily associated to one another in the SLAM algorithm.

As noted above, the navigation and localization system (e.g., navigation and localization system 100) may utilize an error vector checker to determine whether and to what extent the SLAM-algorithm may be inaccurate. If the determined error vector exceeds a predefined criterion, the navigation and localization system may implement countermeasures to avoid further compounding the error. The error vector checker may determine the error vector (e.g., the error vector magnitude or “EVM”) as a positional difference between a reference position, such as a motion-estimated position (e.g., based on the wheel odometry and/or a path planner), and a SLAM-estimated position. Then, if the error vector exceeds a threshold error, the navigation and localization system may remediate the error by either restarting the SLAM-algorithm or by instructing the AMR to return to a location where the error vector was below the threshold error (e.g., a known “good” location).

FIG. 12 shows an example of how the error vector checker may determine an error vector (e.g., the EVM). In this example, the AMR has started at point 1202 and has moved to three different waypoints along a path. The reference position (e.g., a motion-estimated position based on wheel odometry and/or a path planner) is shown along path 1220 (dashed line). The ending motion-estimated position is estimated to be at ending point 1222, where the overall motion-estimated change vector (e.g., from starting point 1202 to ending point 1222) is shown as vector 1221 (e.g., a delta reference vector). The SLAM-estimated position is shown along path 1210, where the ending SLAM-estimated position is estimated to be at ending point 1212, where the overall SLAM-estimated change vector (e.g., from starting point 1202 to ending point 1212) is shown as vector 1211 (e.g., a delta slam vector). Thus, error vector 1230 may be the delta vector between ending point 1222 (as estimated by motion) and ending point 1212 (as estimated by SLAM), and the EVM may be given by:

$$EVM = \frac{\vert \vec{{error}_{vector}} \vert}{\vert \vec{{delta}_{ref}} \vert}$$

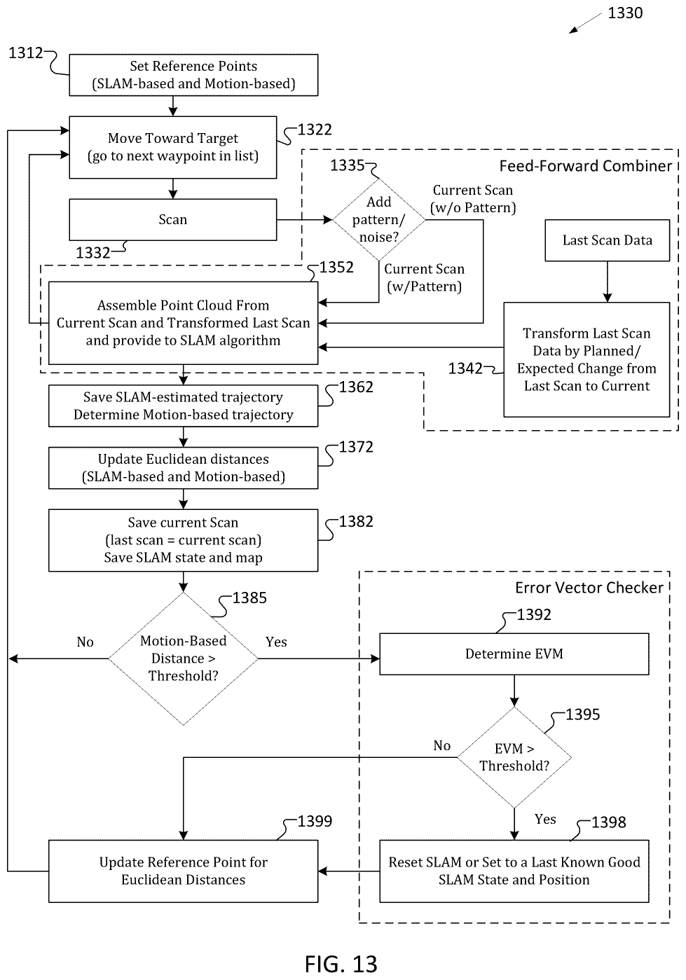

FIG. 13 shows a movement and scan system 1330 that may utilize a feed-forward combiner and/or an error vector checker for monitoring and/or improving the accuracy of SLAM-based positioning. The movement and scan system 1330 may be or be part of a navigation and localization system (e.g., movement and scan system 1330 may be implemented as part of navigation and localization system 100, for example, as part of move/scan loop 130). The movement and scan system 1330 may begin the move/scan loop by, in 1312, setting the reference points for each of the different reference frames (e.g., a reference position for SLAM-estimated positions and a reference position for motion-based estimates). The AMR may, in 1322, move toward the target by selecting the next waypoint in the list and moving toward it. In 1332, the AMR may scan the environment as it moves toward the waypoint(s). If the movement and scan system 1330 uses a feed forward combiner, the movement and scan system 1330 may determine, in 1335, whether to add a known pattern/noise to the scan, where, as discussed above, the added pattern/noise may be used to better associate a position of a key point in one scan to its position, after the AMR has moved, in a later scan. The feed-forward combiner may, in 1342, utilize a previous scan (e.g., last scan data) by transforming it to the current position of the AMR using the planned/expected change in motion of the AMR from the prior position to the current position. The movement and scan system 1330 assembles in 1352 the transformed prior scan data with the current scan data and provides it to the SLAM-algorithm, where the assembled scan data may improve the ability of the SLAM algorithm to associate the locations of key points from the previous scans with their location in the current scan.

In 1362, movement and scan system 1330 saves the SLAM-estimated trajectory/position and determines the reference trajectory/position (e.g., the motion-based trajectory/position using motion sensors, wheel odometry, a path planner, etc.) and in 1372, updates the Euclidean distances in each reference frame (e.g., one based on the SLAM-estimated position and one based on the motion-estimated reference position). The current scan is then, in 1382, saved as the last scan (last scan=current scan) and the new SLAM-estimated position and map is saved. The movement and scan system 1330 may then, in 1382, check whether the reference Euclidean distance (e.g., the distance based on the motion-estimated reference position) satisfies a predefined criterion (e.g., is greater than a threshold distance). If so, the movement and scan system 1330 may determine the error vector magnitude as discussed above (e.g., by determining an error vector between the SLAM-estimated position and motion-estimated reference position and dividing the absolute value of the error vector by the absolute value of the delta vector of the motion-estimated reference position).

If the EVM satisfies a predefined criterion (e.g., is greater than a threshold), then, in 1398, the movement and scan system 1330 may reset the SLAM algorithm (e.g., start afresh with an empty state/map) or may set the SLAM state/map to a previously saved state/map that had a lower error (e.g., a known good SLAM state/map) and navigate the AMR to the position associated with that previously-saved, known-good state/map. Next, the movement and scan system may, in 1330, update the reference point for determining reference distances (e.g., the reference position for motion-based estimates) and return to 1322 to select the next waypoint for moving toward the target, where the move/scan process is repeated until all of the waypoints in the list are processed.

As should be appreciated from the descriptions above, the feed-forward combiner and the error vector checker may each be optional aspects of the movement and scan system 1330. Further, as discussed above, adding a known pattern/noise to the scan may be an optional feature of the feed-forward combiner and/or its usage may depend on, for example, whether there are easily-identifiable key points in the scan of the environment.

Although the feed-forward combiner may be implemented in any manner, an example of a feed-forward combiner is provided in pseudocode below:

```
delta_vector=[x−xold,y−yold];%note the delta vector
%is related to movement in groundtruth. in groundtruth
  cooordinates
% this needs to be first aligned with old pose angle
  (rotationmatrix)!!!!
phiP1=−Vehiclepose1_GT_meter(i1−1,3);
delta_vector_P1aligned=transpose(([[cos(phiP1),
  −sin(phiP1)];[sin(phiP1),cos(phiP1)]])*
  transpose(delta_vector));
phi=−atan2(sin(Vehiclepose1_GT_meter(i1,3)−
  Vehiclepose1_GT_meter(i1−1,3)),
cos(Vehiclepose1_GT_meter(i1,3)−
  Vehiclepose1_GT_meter(i1−1,3)));
last_scan_to_new_scan(:,1:2)=transpose(([[cos(phi),
  −sin(phi)];[sin(phi),cos(phi)]])*
  transpose(oldscan.Cartesian( )−delta_vector_P1aligned));
scan1_Cartesian = [scan.Cartesian;last_scan_to_new_scan];
```

As with the feed-forward combiner, the error vector checker may be implemented in any manner, and an example of an error vector checker implemented in pseudocode code is shown below:

```
%check if teleporting / SLAM Fail happened
deltaREF=Vehiclepose1_GT_meter(end,1:2)−
  current_GT_position_meter(end,1:2);
deltaSLAM=slam_current_pos_meter−slam_old_pos_meter;
%pose_delta_angle = delta angle between slam trajectory
  plane and odometry or reference plane:
  (pose_delta_angle=startPoseGT_lowres(3);)
deltaSLAM_REF=transpose(([[cos(pose_delta_angle),
  −sin(pose_delta_angle)];
  [sin(pose_delta_angle),cos(pose_delta_angle)]])
  *transpose(deltaSLAM));
% error vector magnitude
EVM=norm(deltaSLAM_REF−deltaREF)/norm(deltaREF);
%check if the EVM is within error margins (e.g., 18%,
  when distances are greater than 0.3m)
if EVM > 0.18 && norm(deltaREF)>0.3
% Perform SLAM reset/ or return to known good state
```

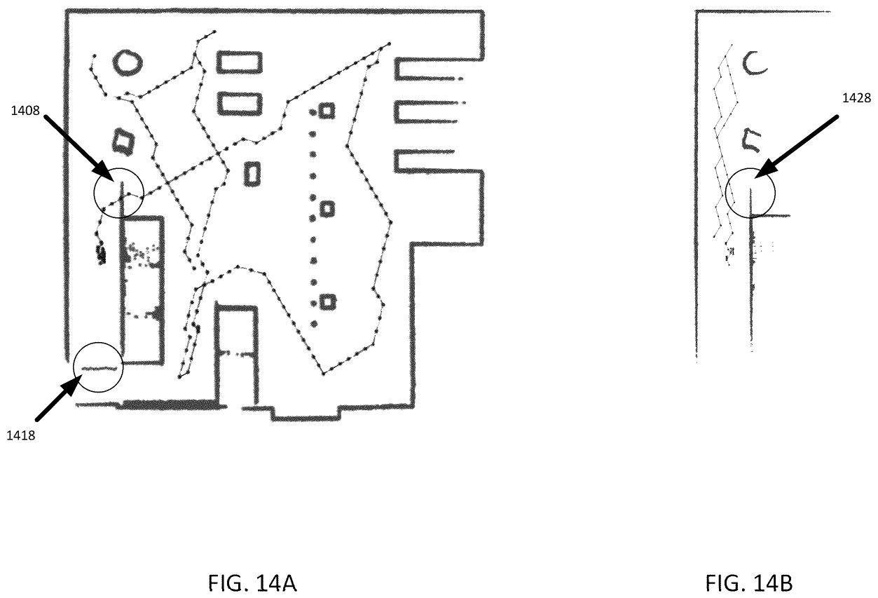

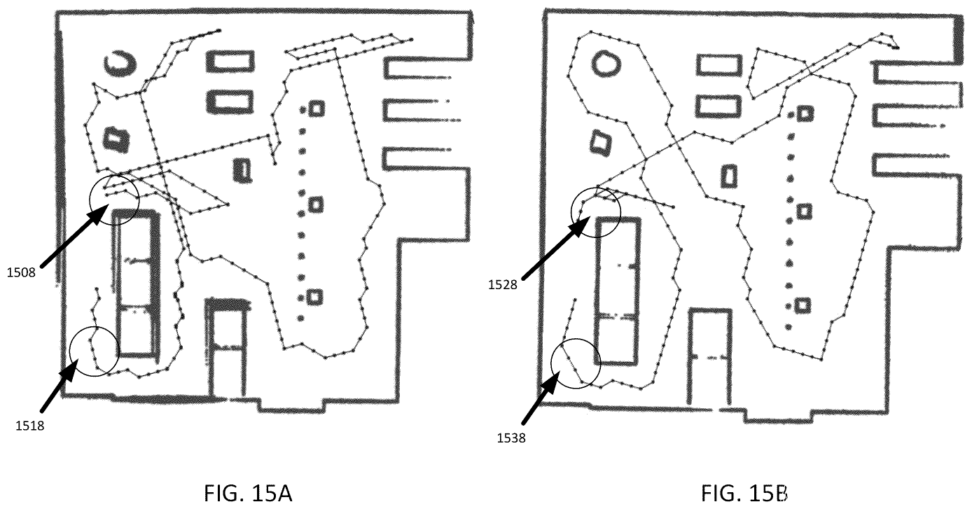

FIGS. 14A and 14B show example experimental results for mapping a room using a conventional SLAM algorithm, while FIGS. 15A and 15B show example experimental results for mapping the same room using an improved SLAM algorithm that implements one or more of the features of the feed-forward combiner and/or the error vector checker described above. As shown in FIG. 14A, inaccurate sensor data has caused several phantoms to appear at different locations on the map (e.g., a phantom protrusion circled at arrow 1408 and a phantom wall circled at arrow 1418). FIG. 14B shows partial results of another exploration path of the AMR in the same room, where inaccurate sensor data has again caused a phantom protrusion to appear on the map (e.g., a phantom protrusion circled at arrow 1428). By contrast, FIGS. 15A and 15B show that when the same room is explored using an improved SLAM algorithm, improved with the features of the feed-forward combiner and/or the error vector checker described above, the mapping accuracy is improved and does not contain phantom protrusions/walls. For example, in FIG. 15A, the AMR's exploration returns clear edges, and the phantom protrusion (e.g., previously at the circled area indicated at arrow 1508, 1528) and phantom wall (e.g., previously at the circled area indicated at arrow 1518, 1538) are no longer corrupting the occupancy grid.

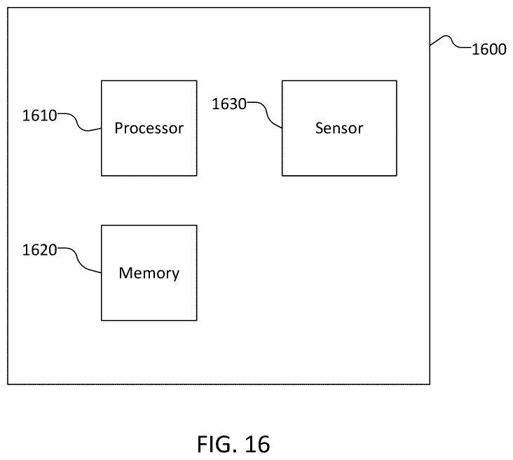

FIG. 16 is a schematic drawing illustrating a device 1600 for navigation and localization of a robot within an environment. The device 1600 may include any of the features of the navigation and localization systems described above (e.g., navigation and localization system 100) with respect to FIGS. 1-15. The navigation and localization system of FIG. 16 may be implemented as a device, a method, and/or a computer readable medium that, when executed, performs the features of the navigation and localization systems described above. It should be understood that device 1600 is only an example, and other configurations may be possible that include, for example, different components or additional components.

Device 1600 includes a processor 1610. In addition to or in combination with any of the features described in the following paragraphs, processor 1610 is configured to obtain an occupancy grid associated with an environment around the robot, wherein the occupancy grid includes grid points of potential destinations for the robot. In addition to or in combination with any of the features described in the following paragraphs, processor 1610 is also configured to determine, for each grid point of the grid points of potential destinations, a weight for the grid point based on a distance to the grid point from a predefined reference point and based on a directional deviation to the grid point, where the directional deviation includes an angular difference between a current heading of the robot and an angular direction from the reference point toward the grid point. In addition to or in combination with any of the features described in the following paragraphs, processor 1610 is also configured to select, based on the weight, a target point from among the grid points. In addition to or in combination with any of the features described in the following paragraphs, processor 1610 is also configured to generate a movement instruction associated with moving the robot toward the target point.

Furthermore, in addition to or in combination with any of the features described in this or the preceding paragraph with respect to device 1600, processor 1610 may be further configured to determine the distance based on a travel path to the grid point from a current position of the robot. Furthermore, in addition to or in combination with any of the features described in this or the preceding paragraph, processor 1610 may be further configured to determine the travel path based on an occupancy characterization (e.g., traversable, occupied (non-traversable), unknown occupancy/unexplored, etc.) associated with each grid point in the occupancy grid along the travel path. Furthermore, in addition to or in combination with any of the features described in this or the preceding paragraph, the weight may be based on a comparison of the distance to a predefined distance criterion. Furthermore, in addition to or in combination with any of the features described in this or the preceding paragraph, the predefined distance criterion may be based on a physical dimension (e.g., radius) of the robot and/or a maximum scan range of a sensor for scanning the environment.

Furthermore, in addition to or in combination with any of the features described in this or the preceding two paragraphs with respect to device 1600, processor 1610 may be further configured to determine the weight based on a first weighting factor associated with the distance and based on a second weighting factor associated with the directional deviation, wherein the second weighting factor is based on the comparison of the distance to the predefined distance criterion (e.g., the larger the distance to the grid point, the less the directional weighting). Furthermore, in addition to or in combination with any of the features described in this or the preceding two paragraphs, processor 1610 may be further configured to include a grid point in the grid points of potential destinations based on whether the grid point is a predefined distance to a boundary defined by unexplored points in the occupancy grid in relation to explored points in the occupancy grid. Furthermore, in addition to or in combination with any of the features described in this or the preceding two paragraphs, processor 1610 may be further configured to include a grid point in the grid points of potential destinations based on whether the grid point is a predefined distance to an occupied point in the occupancy grid. Furthermore, in addition to or in combination with any of the features described in this or the preceding two paragraphs, the occupied point may represent non-traversable space in the occupancy grid.

Furthermore, in addition to or in combination with any of the features described in this or the preceding three paragraphs with respect to device 1600, processor 1610 may be further configured to determine the weight for each grid point based on whether the grid point is reachable by the robot. Furthermore, in addition to or in combination with any of the features described in this or the preceding three paragraphs, the reference point may include an actual position of the robot, an estimated position of the robot, or a planned position of the robot within the occupancy grid. Furthermore, in addition to or in combination with any of the features described in this or the preceding three paragraphs, the occupancy grid may be associated with a first resolution defined by a dimension of the grid points, wherein processor 1610 may be further configured to align a current location of the robot to a sampling point of sensor data indicative of the environment and to resample the occupancy grid into a coarse occupancy grid associated with a second resolution defined by a second dimension of resampled grid points, wherein the second dimension is larger than the first dimension. Furthermore, in addition to or in combination with any of the features described in this or the preceding three paragraphs, processor 1610 may be further configured to determine a travel path toward at least one of the potential destinations based on an occupancy characterization (e.g., traversable, occupied (not traversable), unknown occupancy/unexplored, etc.) associated with each resampled grid point in the coarse occupancy grid along the travel path. Furthermore, in addition to or in combination with any of the features described in this or the preceding three paragraphs, processor 1610 may be further configured to determine the travel path based on a raytracing from a current position of the robot within the coarse occupancy grid.

Furthermore, in addition to or in combination with any of the features described in this or the preceding four paragraphs with respect to device 1600, processor 1610 may be further configured to, if a next waypoint along the travel path from a current position of the robot has a non-traversable occupancy characterization, provide a reverse instruction to the robot, wherein the reverse instruction indicates that the robot should reverse along a previously traveled path used to arrive at the current position. Furthermore, in addition to or in combination with any of the features described in this or the preceding four paragraphs, the reverse instruction may indicate that the robot should reverse along the traveled path without regard to an occupancy characterization of the grid points in the occupancy grid that are along the traveled path. Furthermore, in addition to or in combination with any of the features described in this or the preceding four paragraphs, processor 1610 may be further configured to, based on the reverse instruction, decrease the weight of the grid point associated with the least one of the potential destinations. Furthermore, in addition to or in combination with any of the features described in this or the preceding four paragraphs, processor 1610 may be further configured to receive an updated set of sensor data at a location along the previously traveled path and to provide, based on whether the updated set of sensor data satisfies a predetermined safety criterion, an end-reverse instruction to the robot, wherein the end-reverse instruction indicates that the robot should stop reversing along the previously traveled path. Furthermore, in addition to or in combination with any of the features described in this or the preceding four paragraphs, the predetermined safety criterion may include an indication that in the occupancy grid there is sufficient unoccupied space around the robot to navigate.

Furthermore, in addition to or in combination with any of the features described in this or the preceding five paragraphs, device 1600 may further include a memory 1620 configured to store at least one of the occupancy grid, the grid points of potential destinations, the weight, the directional deviation, the angular difference, the current heading, and/or the angular direction. Furthermore, in addition to or in combination with any of the features described in this or the preceding five paragraphs, processor 1610 configured to obtain the occupancy grid may include processor 1610 configured to determine the occupancy grid based on a set of sensor data indicative of the environment around the robot. Furthermore, in addition to or in combination with any of the features described in this or the preceding five paragraphs, the set of sensor data may include a point cloud of distance measurements/vectors. Furthermore, in addition to or in combination with any of the features described in this or the preceding five paragraphs, the set of sensor data may include a point cloud of distance measurements from a light detection and ranging sensor. Furthermore, in addition to or in combination with any of the features described in this or the preceding five paragraphs, device 1600 may further include a sensor 1630 (e.g., a LiDAR system, a camera system, etc.) configured to provide the set of sensor data to processor 1610.

Additionally or alternatively, device 1600 is for localization of a robot and includes a processor 1610 configured to obtain an expected position of the robot in relation to a prior position of the robot within the environment. In addition to or in combination with any of the features described in the following paragraphs, processor 1610 is also configured to obtain prior scan data of the environment at the prior position and a previous key point within the prior scan data. In addition to or in combination with any of the features described in the following paragraphs, processor 1610 is also configured to translate, based on a difference between the prior position and the expected position, the prior scan data into transformed scan data. In addition to or in combination with any of the features described in the following paragraphs, processor 1610 is also configured to obtain current scan data of the environment at a current position of the robot. In addition to or in combination with any of the features described in the following paragraphs, processor 1610 is also configured to combine the current scan data with the transformed scan data as combined scan data. In addition to or in combination with any of the features described in the following paragraphs, processor 1610 is also configured to identify an observed key point based on the combined scan data. In addition to or in combination with any of the features described in the following paragraphs, processor 1610 is also configured to determine a correlation between the observed key point and the previous key point. In addition to or in combination with any of the features described in the following paragraphs, processor 1610 is also configured to determine an estimated actual position of the robot based on the correlation and the expected position.

Furthermore, in addition to or in combination with any of the features described in this or the preceding paragraph with respect to device 1600, processor 1610 may be configured to determine the expected position based on an odometry change from the prior position to the current position. Furthermore, in addition to or in combination with any of the features described in this or the preceding paragraph, processor 1610 may be configured to determine the expected position based on a planned trajectory of the robot with respect to the prior position. Furthermore, in addition to or in combination with any of the features described in this or the preceding paragraph, the prior scan data may include a point cloud of points, wherein the previous key point within the prior scan data may include one or more of the points of the point cloud. Furthermore, in addition to or in combination with any of the features described in this or the preceding paragraph, the combined scan data may include a combined point cloud of combined points, wherein the observed key point within the combined scan data may include one or more of the combined points of the combined point cloud. Furthermore, in addition to or in combination with any of the features described in this or the preceding paragraph, processor 1610 may be configured to add an injected noise pattern to the prior scan data, wherein the injected noise pattern defines a simulated key point in the prior scan data. Furthermore, in addition to or in combination with any of the features described in this or the preceding paragraph, processor 1610 may be configured to add the injected noise pattern in a region of the prior scan data that positionally overlaps with the current scan data. Furthermore, in addition to or in combination with any of the features described in this or the preceding paragraph, processor 1610 configured to translate the prior scan data into transformed scan data may include processor 1610 configured to, based on the difference between the prior position and the expected position, translate coordinate points of the prior scan data that are based on the prior position into new coordinate points of the transformed scan data that are based on the expected position.

Furthermore, in addition to or in combination with any of the features described in this or the preceding two paragraphs with respect to device 1600, processor 1610 may be configured to obtain a plurality of prior scan data sets, wherein each set of the prior scan data sets is at one of a plurality of prior positions of the robot, wherein one of the prior scan data sets includes the prior scan data and one of the plurality of prior positions includes the prior position. Furthermore, in addition to or in combination with any of the features described in this or the preceding two paragraphs, processor 1610 may be further configured to identify a plurality of previous key points at the prior position, wherein the previous key point includes one of the plurality of previous key points, wherein the processor is further configured to identify a plurality of observed key points based on the combined scan data wherein the observed key point is one of the plurality of observed key points, wherein the processor is further configured to determine the correlation between the observed key points and the previous key points. Furthermore, in addition to or in combination with any of the features described in this or the preceding two paragraphs, processor 1610 may be further configured to determine the correlation based on a directional uncertainty of the previous key point and/or the observed key point.

Furthermore, in addition to or in combination with any of the features described in this or the preceding three paragraphs with respect to device 1600, the prior scan data and/or current scan data may include a point cloud of distance measurements/vectors, wherein the previous key point and/or observed key point includes a point or group of points in the point cloud. Furthermore, in addition to or in combination with any of the features described in this or the preceding three paragraphs, the prior scan data and/or current scan data include image data, wherein the previous key point and/or observed key point includes a point extracted from the image data. Furthermore, in addition to or in combination with any of the features described in this or the preceding three paragraphs, processor 1610 may be configured to determine the correlation between the observed key point and the previous key point based on the combined scan data. Furthermore, in addition to or in combination with any of the features described in this or the preceding three paragraphs, processor 1610 may be configured to determine the correlation between the observed key point and the previous key point based on a simultaneous localization and mapping (SLAM) equation solver algorithm that uses the combined scan data as an input to the SLAM equation solver.

Additionally or alternatively, device 1600 may be for localization and control of a robot and include a processor 1610 configured to determine a first movement vector based on an odometry change from a prior position of the robot or based on a planned/expected movement of the robot from the prior position. In addition to or in combination with any of the features described in the following paragraphs, processor 1610 is also configured to determine a second movement vector based on a localization algorithm with respect to a current sensor scan in relation to the prior position. In addition to or in combination with any of the features described in the following paragraphs, processor 1610 is also configured to determine an error vector between the first movement vector and the second movement vector. In addition to or in combination with any of the features described in the following paragraphs, processor 1610 is also configured to determine a mitigation strategy based on based on whether the error vector satisfies a predetermined error criterion. In addition to or in combination with any of the features described in the following paragraphs, processor 1610 is also configured to generate an instruction to control the robot based on the mitigation strategy.

Furthermore, in addition to or in combination with any of the features described in this or the preceding paragraph with respect to device 1600, the mitigation strategy may include a reset of the localization algorithm. Furthermore, in addition to or in combination with any of the features described in this or the preceding paragraph, the mitigation strategy may include a return of the robot to the prior position or a previous position with an associated error vector that satisfies the predetermined criterion. Furthermore, in addition to or in combination with any of the features described in this or the preceding paragraph, processor 1610 configured to determine the first movement vector may include processor 1610 configured to determine the first movement vector based on whether the planned/expected movement includes as least one translational motion. Furthermore, in addition to or in combination with any of the features described in this or the preceding paragraph, the localization algorithm may include a simultaneous localization and mapping (SLAM)-based algorithm. Furthermore, in addition to or in combination with any of the features described in this or the preceding paragraph, processor 1610 may be further configured to determine the mitigation strategy based on whether a Euclidian reference distance satisfies a predetermined criterion, wherein the Euclidian reference distance is defined by the first movement vector. Furthermore, in addition to or in combination with any of the features described in this or the preceding paragraph, the error vector may include a normalized error vector magnitude. Furthermore, in addition to or in combination with any of the features described in this or the preceding paragraph, the error vector may include a normalized error vector magnitude expressed as a percentage of a magnitude the first movement vector.

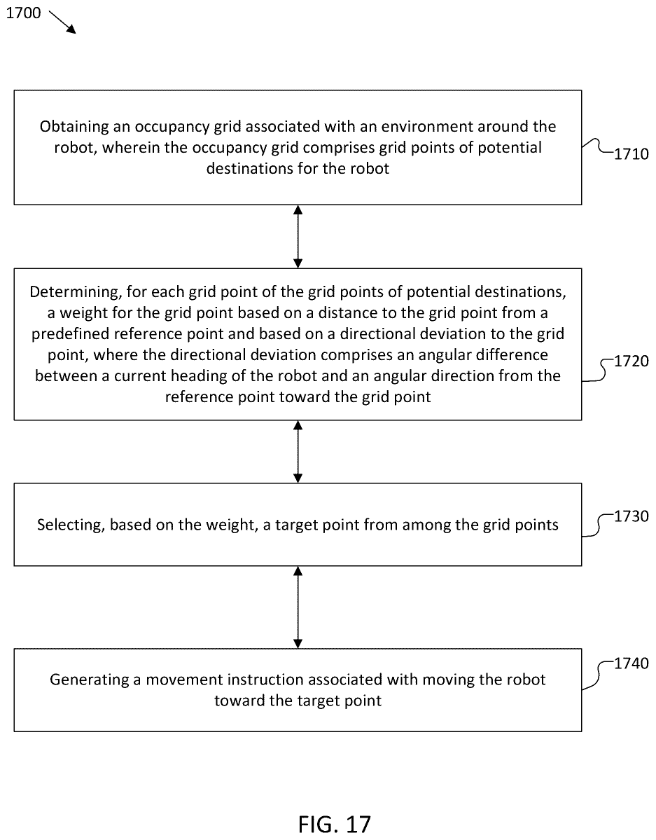

FIG. 17 depicts a schematic flow diagram of a method 1700 for navigating a robot. Method 1700 may implement any of the features of the navigation and localization systems described above (e.g., navigation and localization system 100) with respect to FIGS. 1-16.

Method 1700 includes, in 1710, obtaining an occupancy grid associated with an environment around the robot, wherein the occupancy grid comprises grid points of potential destinations for the robot. Method 1700 also includes, in 1720, determining, for each grid point of the grid points of potential destinations, a weight for the grid point based on a distance to the grid point from a predefined reference point and based on a directional deviation to the grid point, where the directional deviation comprises an angular difference between a current heading of the robot and an angular direction from the reference point toward the grid point. Method 1700 also includes, in 1730, selecting, based on the weight, a target point from among the grid points. Method 1700 also includes, in 1740, generating a movement instruction associated with moving the robot toward the target point.

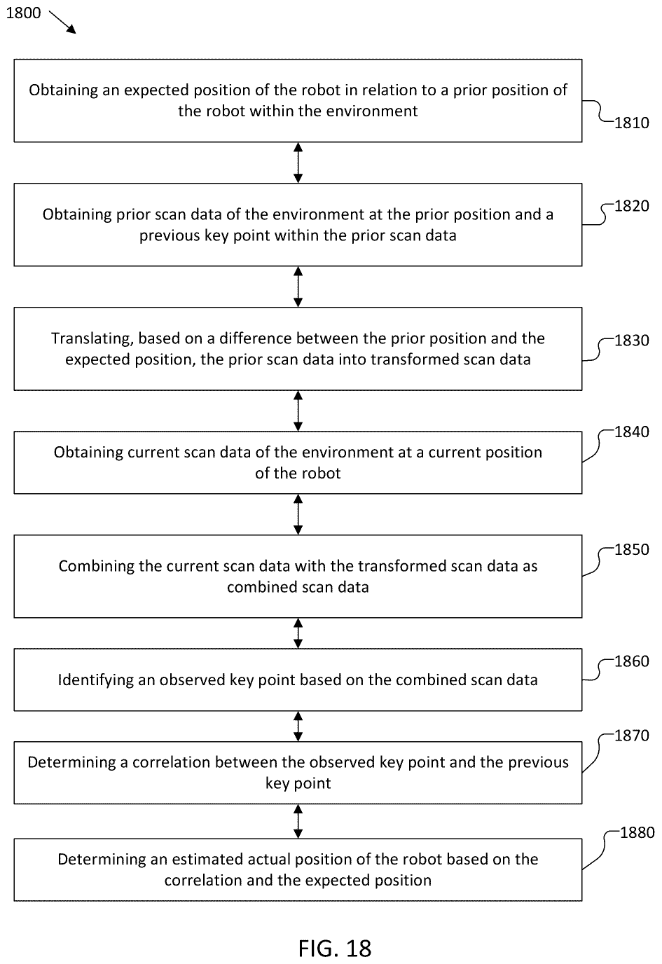

FIG. 18 depicts a schematic flow diagram of a method 1800 for localization of a robot. Method 1800 may implement any of the features of the navigation and localization systems described above (e.g., navigation and localization system 100) with respect to FIGS. 1-17.

Method 1800 includes, in 1810, obtaining an expected position of the robot in relation to a prior position of the robot within the environment. Method 1800 also includes, in 1820, obtaining prior scan data of the environment at the prior position and a previous key point within the prior scan data. Method 1800 also includes, in 1830, translating, based on a difference between the prior position and the expected position, the prior scan data into transformed scan data. Method 1800 also includes, in 1840, obtaining current scan data of the environment at a current position of the robot. Method 1800 also includes, in 1850, combining the current scan data with the transformed scan data as combined scan data. Method 1800 also includes, in 1860, identifying an observed key point based on the combined scan data. Method 1800 also includes, in 1870, determining a correlation between the observed key point and the previous key point. Method 1800 also includes, in 1880, determining an estimated actual position of the robot based on the correlation and the expected position.

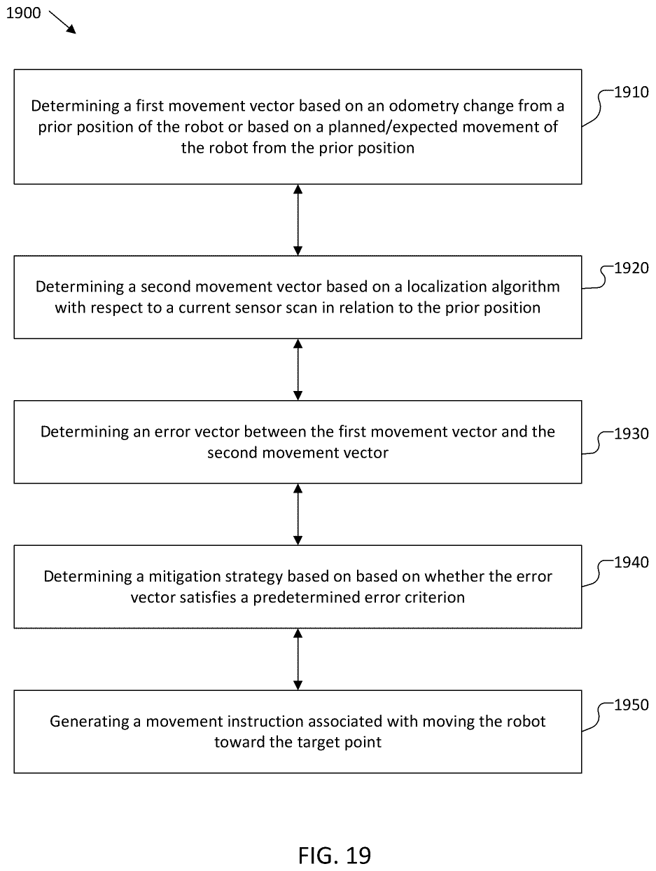

FIG. 19 depicts a schematic flow diagram of a method 1900 for localization and control of a robot. Method 1900 may implement any of the features of the navigation and localization systems described above (e.g., navigation and localization system 100) with respect to FIGS. 1-18.

Method 1900 includes, in 1910, determining a first movement vector based on an odometry change from a prior position of the robot or based on a planned/expected movement of the robot from the prior position. Method 1900 also includes, in 1920, determining a second movement vector based on a localization algorithm with respect to a current sensor scan in relation to the prior position. Method 1900 also includes, in 1930, determining an error vector between the first movement vector and the second movement vector. Method 1900 also includes, in 1940, determining a mitigation strategy based on based on whether the error vector satisfies a predetermined error criterion. Method 1900 also includes, in 1950, generating an instruction to control the robot based on the mitigation strategy.

In the following, various examples are provided that may include one or more features of the energy configuration systems described above, for example with reference to FIGS. 1-19. It may be intended that aspects described in relation to the devices may apply also to the described method(s), and vice versa.

Example 1 is a device for navigating a robot, the device including a processor configured to obtain an occupancy grid associated with an environment around the robot, wherein the occupancy grid includes grid points of potential destinations for the robot. The processor is also configured to determine, for each grid point of the grid points of potential destinations, a weight for the grid point based on a distance to the grid point from a predefined reference point and based on a directional deviation to the grid point, where the directional deviation includes an angular difference between a current heading of the robot and an angular direction from the reference point toward the grid point. The processor is also configured to select, based on the weight, a target point from among the grid points. The processor is also configured to generate a movement instruction associated with moving the robot toward the target point.

Example 2 is the device of example 1, wherein the processor is further configured to determine the distance based on a travel path to the grid point from a current position of the robot.

Example 3 is the device of example 2, wherein the processor is further configured to determine the travel path based on an occupancy characterization (e.g., traversable, occupied (non-traversable), unknown occupancy/unexplored, etc.) associated with each grid point in the occupancy grid along the travel path.

Example 4 is the device of any one of examples 1 to 3, wherein the weight is based on a comparison of the distance to a predefined distance criterion.

Example 5 is the device of example 4, wherein the predefined distance criterion is based on a physical dimension (e.g., radius) of the robot and/or a maximum scan range of a sensor for scanning the environment.

Example 6 is the device of either of examples 4 or 5, wherein the processor is further configured to determine the weight based on a first weighting factor associated with the distance and based on a second weighting factor associated with the directional deviation, wherein the second weighting factor is based on the comparison of the distance to the predefined distance criterion (e.g., the larger the distance to the grid point, the less the directional weighting).

Example 7 is the device of any one of examples 1 to 6, wherein the processor is further configured to include a grid point in the grid points of potential destinations based on whether the grid point is a predefined distance to a boundary defined by unexplored points in the occupancy grid in relation to explored points in the occupancy grid.

Example 8 is the device of any one of examples 1 to 7, wherein the processor is further configured to include a grid point in the grid points of potential destinations based on whether the grid point is a predefined distance to an occupied point in the occupancy grid.

Example 9 is the device of example 8, wherein the occupied point represents non-traversable space in the occupancy grid.

Example 10 is the device of any one of examples 1 to 9, wherein the processor is further configured to determine the weight for each grid point based on whether the grid point is reachable by the robot.

Example 11 is the device of any one of examples 1 to 10, wherein the reference point includes an actual position of the robot, an estimated position of the robot, or a planned position of the robot within the occupancy grid.

Example 12 is the device of any one of examples 1 to 11, wherein the occupancy grid is associated with a first resolution defined by a dimension of the grid points, wherein the processor is further configured to align a current location of the robot to a sampling point of sensor data indicative of the environment. The processor is further configured to resample the occupancy grid into a coarse occupancy grid associated with a second resolution defined by a second dimension of resampled grid points, wherein the second dimension is larger than the first dimension.

Example 13 is the device of example 12, wherein the processor is further configured to determine a travel path toward at least one of the potential destinations based on an occupancy characterization (e.g., traversable, occupied (not traversable), unknown occupancy/unexplored, etc.) associated with each resampled grid point in the coarse occupancy grid along the travel path.

Example 14 is the device of example 13, wherein the processor is further configured to determine the travel path based on a raytracing from a current position of the robot within the coarse occupancy grid.

Example 15 is the device of any one of examples 1 to 14, wherein the processor is further configured to, if a next waypoint along the travel path from a current position of the robot has a non-traversable occupancy characterization, provide a reverse instruction to the robot, wherein the reverse instruction indicates that the robot is to reverse along a previously traveled path used to arrive at the current position.

Example 16 is the device of example 15, wherein the reverse instruction indicates that the robot is to reverse along the traveled path without regard to an occupancy characterization of the grid points in the occupancy grid that are along the traveled path.

Example 17 is the device of either one of examples 15 to 16, wherein the processor is further configured to, based on the reverse instruction, decrease the weight of the grid point associated with the least one of the potential destinations.

Example 18 is the device of either one of examples 16 to 17, wherein the processor is further configured to receive an updated set of sensor data at a location along the previously traveled path. The processor is further configured to provide, based on whether the updated set of sensor data satisfies a predetermined safety criterion, an end-reverse instruction to the robot, wherein the end-reverse instruction indicates that the robot is to stop reversing along the previously traveled path.

Example 19 is the device of example 18, wherein the predetermined safety criterion includes an indication that in the occupancy grid there is sufficient unoccupied space around the robot to navigate.

Example 20 is the device of any one of examples 1 to 19, the device further including a memory configured to store at least one of the occupancy grid, the grid points of potential destinations, the weight, the directional deviation, the angular difference, the current heading, and/or the angular direction.

Example 21 is the device of any one of examples 1 to 20, wherein the processor configured to obtain the occupancy grid includes the processor configured to determine the occupancy grid based on a set of sensor data indicative of the environment around the robot.

Example 22 is the device of example 21, wherein the set of sensor data includes a point cloud of distance measurements/vectors.

Example 23 is the device of example 21, wherein the set of sensor data includes a point cloud of distance measurements from a light detection and ranging sensor.

Example 24 is the device of any one of examples 1 to 23, the device further including a sensor (e.g., a LiDAR system, a camera system, etc.) configured to provide the set of sensor data to the processor.

Example 25 is a device for localization of a robot, the device including a processor configured to obtain an expected position of the robot in relation to a prior position of the robot within the environment. The processor is also configured to obtain prior scan data of the environment at the prior position and a previous key point within the prior scan data. The processor is also configured to translate, based on a difference between the prior position and the expected position, the prior scan data into transformed scan data. The processor is also configured to obtain current scan data of the environment at a current position of the robot. The processor is also configured to combine the current scan data with the transformed scan data as combined scan data. The processor is also configured to identify an observed key point based on the combined scan data. The processor is also configured to determine a correlation between the observed key point and the previous key point. The processor is also configured to determine an estimated actual position of the robot based on the correlation and the expected position.

Example 26 is the device of example 25, wherein the processor is configured to determine the expected position based on an odometry change from the prior position to the current position.

Example 27 is the device of either one of examples 25 or 26, wherein the processor is configured to determine the expected position based on a planned trajectory of the robot with respect to the prior position.

Example 28 is the device of any one of examples 25 to 27, wherein the prior scan data includes a point cloud of points, wherein the previous key point within the prior scan data includes one or more of the points of the point cloud.

Example 29 is the device of any one of examples 25 to 28, wherein the combined scan data includes a combined point cloud of combined points, wherein the observed key point within the combined scan data includes one or more of the combined points of the combined point cloud.

Example 30 is the device of any one of examples 25 to 29, wherein the processor is configured to add an injected noise pattern to the prior scan data, wherein the injected noise pattern defines a simulated key point in the prior scan data.

Example 31 is the device of example 30, wherein the processor is configured to add the injected noise pattern in a region of the prior scan data that positionally overlaps with the current scan data.

Example 32 is the device of any one of examples 25 to 31, wherein the processor configured to translate the prior scan data into transformed scan data includes the processor configured to, based on the difference between the prior position and the expected position, translate coordinate points of the prior scan data that are based on the prior position into new coordinate points of the transformed scan data that are based on the expected position.

Example 33 is the device of any one of examples 25 to 32, wherein the processor is configured to obtain a plurality of prior scan data sets, wherein each set of the prior scan data sets is at one of a plurality of prior positions of the robot, wherein one of the prior scan data sets includes the prior scan data and one of the plurality of prior positions includes the prior position.

Example 34 is the device of any one of examples 25 to 33, wherein the processor is further configured to identify a plurality of previous key points at the prior position, wherein the previous key point includes one of the plurality of previous key points, wherein the processor is further configured to identify a plurality of observed key points based on the combined scan data wherein the observed key point is one of the plurality of observed key points, wherein the processor is further configured to determine the correlation between the observed key points and the previous key points.

Example 35 is the device of any one of examples 25 to 34, wherein the processor is further configured to determine the correlation based on a directional uncertainty of the previous key point and/or the observed key point.

Example 36 is the device of any one of examples 25 to 35, wherein the prior scan data and/or current scan data include a point cloud of distance measurements/vectors, wherein the previous key point and/or observed key point includes a point or group of points in the point cloud.

Example 37 is the device of any one of examples 25 to 36, wherein the prior scan data and/or current scan data include image data, wherein the previous key point and/or observed key point includes a point extracted from the image data.

Example 38 is the device of any one of examples 25 to 37, wherein the processor is configured to determine the correlation between the observed key point and the previous key point based on the combined scan data.

Example 39 is the device of any one of examples 25 to 38, wherein the processor is configured to determine the correlation between the observed key point and the previous key point based on a simultaneous localization and mapping (SLAM) equation solver algorithm that uses the combined scan data as an input to the SLAM equation solver.

Example 40 is a device for localization and control of a robot, the device including a processor configured to determine a first movement vector based on an odometry change from a prior position of the robot or based on a planned/expected movement of the robot from the prior position. The processor is also configured to determine a second movement vector based on a localization algorithm with respect to a current sensor scan in relation to the prior position. The processor is also configured to determine an error vector between the first movement vector and the second movement vector. The processor is also configured to determine a mitigation strategy based on based on whether the error vector satisfies a predetermined error criterion. The processor is also configured to generate an instruction to control the robot based on the mitigation strategy.

Example 41 is the device of example 40, wherein the mitigation strategy includes a reset of the localization algorithm.

Example 42 is the device of either of examples 40 or 41, wherein the mitigation strategy includes a return of the robot to the prior position or a previous position with an associated error vector that satisfies the predetermined criterion.

Example 43 is the device of any one of examples 40 to 42, wherein the processor configured to determine the first movement vector includes the processor configured to determine the first movement vector based on whether the planned/expected movement includes as least one translational motion.

Example 44 is the device of any of examples 40 to 43, wherein the localization algorithm includes a simultaneous localization and mapping (SLAM)-based algorithm.

Example 45 is the device of any of examples 40 to 44, wherein the processor is further configured to determine the mitigation strategy based on whether a Euclidian reference distance satisfies a predetermined criterion, wherein the Euclidian reference distance is defined by the first movement vector.

Example 46 is the device of any of examples 40 to 45, wherein the error vector includes a normalized error vector magnitude.

Example 47 is the device of any of examples 40 to 46, wherein the error vector includes a normalized error vector magnitude expressed as a percentage of a magnitude the first movement vector.

Example 48 is a method for navigating a robot, the method including obtaining an occupancy grid associated with an environment around the robot, wherein the occupancy grid includes grid points of potential destinations for the robot. The method also includes determining, for each grid point of the grid points of potential destinations, a weight for the grid point based on a distance to the grid point from a predefined reference point and based on a directional deviation to the grid point, where the directional deviation includes an angular difference between a current heading of the robot and an angular direction from the reference point toward the grid point. The method also includes selecting, based on the weight, a target point from among the grid points. The method also includes generating a movement instruction associated with moving the robot toward the target point.

Example 49 is the method of example 48, wherein the method further includes determining the distance based on a travel path to the grid point from a current position of the robot.

Example 50 is the method of example 49, wherein the method further includes determining the travel path based on an occupancy characterization (e.g., traversable, occupied (non-traversable), unknown occupancy/unexplored, etc.) associated with each grid point in the occupancy grid along the travel path.

Example 51 is the method of any one of examples 48 to 50, wherein the weight is based on a comparison of the distance to a predefined distance criterion.

Example 52 is the method of example 51, wherein the predefined distance criterion is based on a physical dimension (e.g., radius) of the robot and/or a maximum scan range of a sensor for scanning the environment.

Example 53 is the method of either of examples 51 or 52, wherein the method further includes determining the weight based on a first weighting factor associated with the distance and based on a second weighting factor associated with the directional deviation, wherein the second weighting factor is based on the comparison of the distance to the predefined distance criterion (e.g., the larger the distance to the grid point, the less the directional weighting).

Example 54 is the method of any one of examples 48 to 53, wherein the method further includes including a grid point in the grid points of potential destinations based on whether the grid point is a predefined distance to a boundary defined by unexplored points in the occupancy grid in relation to explored points in the occupancy grid.

Example 55 is the method of any one of examples 48 to 54, wherein the method further includes including a grid point in the grid points of potential destinations based on whether the grid point is a predefined distance to an occupied point in the occupancy grid.

Example 56 is the method of example 55, wherein the occupied point represents non-traversable space in the occupancy grid.

Example 57 is the method of any one of examples 48 to 56, wherein the method further includes determining the weight for each grid point based on whether the grid point is reachable by the robot.

Example 58 is the method of any one of examples 48 to 57, wherein the reference point includes an actual position of the robot, an estimated position of the robot, or a planned position of the robot within the occupancy grid.

Example 59 is the method of any one of examples 48 to 58, wherein the occupancy grid is associated with a first resolution defined by a dimension of the grid points, wherein the method further includes aligning a current location of the robot to a sampling point of sensor data indicative of the environment. The method further includes resampling the occupancy grid into a coarse occupancy grid associated with a second resolution defined by a second dimension of resampled grid points, wherein the second dimension is larger than the first dimension.

Example 60 is the method of example 59, wherein the method further includes determining a travel path toward at least one of the potential destinations based on an occupancy characterization (e.g., traversable, occupied (not traversable), unknown occupancy/unexplored, etc.) associated with each resampled grid point in the coarse occupancy grid along the travel path.

Example 61 is the method of example 60, wherein the method further includes determining the travel path based on a raytracing from a current position of the robot within the coarse occupancy grid.

Example 62 is the method of any one of examples 48 to 61, wherein the method further includes providing, if a next waypoint along the travel path from a current position of the robot has a non-traversable occupancy characterization, a reverse instruction to the robot, wherein the reverse instruction indicates that the robot is to reverse along a previously traveled path used to arrive at the current position.

Example 63 is the method of example 62, wherein the reverse instruction indicates that the robot is to reverse along the traveled path without regard to an occupancy characterization of the grid points in the occupancy grid that are along the traveled path.

Example 64 is the method of either one of examples 62 to 63, wherein the method further includes decreasing, based on the reverse instruction, the weight of the grid point associated with the least one of the potential destinations.

Example 65 is the method of either one of examples 63 to 64, wherein the method further includes receiving an updated set of sensor data at a location along the previously traveled path. The method further includes providing, based on whether the updated set of sensor data satisfies a predetermined safety criterion, an end-reverse instruction to the robot, wherein the end-reverse instruction indicates that the robot is to stop reversing along the previously traveled path.

Example 66 is the method of example 65, wherein the predetermined safety criterion includes an indication that in the occupancy grid there is sufficient unoccupied space around the robot to navigate.

Example 67 is the method of any one of examples 48 to 66, the method further includes storing (e.g., in a memory) at least one of the occupancy grid, the grid points of potential destinations, the weight, the directional deviation, the angular difference, the current heading, and/or the angular direction.

Example 68 is the method of any one of examples 48 to 67, wherein obtaining the occupancy grid includes determining the occupancy grid based on a set of sensor data indicative of the environment around the robot.

Example 69 is the method of example 68, wherein the set of sensor data includes a point cloud of distance measurements/vectors.

Example 70 is the method of example 68, wherein the set of sensor data includes a point cloud of distance measurements from a light detection and ranging sensor.

Example 71 is the method of any one of examples 48 to 70, the method further including receiving from a sensor (e.g., a LiDAR system, a camera system, etc.) the set of sensor data.

Example 72 is a method for localization of a robot, the method including obtaining an expected position of the robot in relation to a prior position of the robot within the environment. The method also includes obtaining prior scan data of the environment at the prior position and a previous key point within the prior scan data. The method also includes translating, based on a difference between the prior position and the expected position, the prior scan data into transformed scan data. The method also includes obtaining current scan data of the environment at a current position of the robot. The method also includes combining the current scan data with the transformed scan data as combined scan data. The method also includes identifying an observed key point based on the combined scan data. The method also includes determining a correlation between the observed key point and the previous key point. The method also includes determining an estimated actual position of the robot based on the correlation and the expected position.

Example 73 is the method of example 72, wherein the method includes determining the expected position based on an odometry change from the prior position to the current position.

Example 74 is the method of either one of examples 72 or 73, wherein the method further includes determining the expected position based on a planned trajectory of the robot with respect to the prior position.

Example 75 is the method of any one of examples 72 to 74, wherein the prior scan data includes a point cloud of points, wherein the previous key point within the prior scan data includes one or more of the points of the point cloud.

Example 76 is the method of any one of examples 72 to 75, wherein the combined scan data includes a combined point cloud of combined points, wherein the observed key point within the combined scan data includes one or more of the combined points of the combined point cloud.

Example 77 is the method of any one of examples 72 to 76, wherein the method includes adding an injected noise pattern to the prior scan data, wherein the injected noise pattern defines a simulated key point in the prior scan data.

Example 78 is the method of example 77, wherein the method includes adding the injected noise pattern in a region of the prior scan data that positionally overlaps with the current scan data.

Example 79 is the method of any one of examples 72 to 78, wherein translating the prior scan data into transformed scan data includes translating, based on the difference between the prior position and the expected position, coordinate points of the prior scan data that are based on the prior position into new coordinate points of the transformed scan data that are based on the expected position.

Example 80 is the method of any one of examples 72 to 79, wherein the method includes obtaining a plurality of prior scan data sets, wherein each set of the prior scan data sets is at one of a plurality of prior positions of the robot, wherein one of the prior scan data sets includes the prior scan data and one of the plurality of prior positions includes the prior position.

Example 81 is the method of any one of examples 72 to 80, wherein the method further includes identifying a plurality of previous key points at the prior position, wherein the previous key point includes one of the plurality of previous key points, wherein the method further includes identifying a plurality of observed key points based on the combined scan data wherein the observed key point is one of the plurality of observed key points, wherein the method further includes determining the correlation between the observed key points and the previous key points.

Example 82 is the method of any one of examples 72 to 81, wherein the method further includes determining the correlation based on a directional uncertainty of the previous key point and/or the observed key point.

Example 83 is the method of any one of examples 72 to 82, wherein the prior scan data and/or current scan data include a point cloud of distance measurements/vectors, wherein the previous key point and/or observed key point includes a point or group of points in the point cloud.

Example 84 is the method of any one of examples 72 to 83, wherein the prior scan data and/or current scan data include image data, wherein the previous key point and/or observed key point includes a point extracted from the image data.

Example 85 is the method of any one of examples 72 to 84, wherein the method further includes determining the correlation between the observed key point and the previous key point based on the combined scan data.

Example 86 is the method of any one of examples 72 to 85, wherein the method further includes determining the correlation between the observed key point and the previous key point based on a simultaneous localization and mapping (SLAM) equation solver algorithm that uses the combined scan data as an input to the SLAM equation solver.

Example 87 is a method for localization and control of a robot, the method including determining a first movement vector based on an odometry change from a prior position of the robot or based on a planned/expected movement of the robot from the prior position. The method also includes determining a second movement vector based on a localization algorithm with respect to a current sensor scan in relation to the prior position. The method also includes determining an error vector between the first movement vector and the second movement vector. The method also includes determining a mitigation strategy based on based on whether the error vector satisfies a predetermined error criterion. The method also includes generating an instruction to control the robot based on the mitigation strategy.

Example 88 is the method of example 87, wherein the mitigation strategy includes a reset of the localization algorithm.

Example 89 is the method of either of examples 87 or 88, wherein the mitigation strategy includes a return of the robot to the prior position or a previous position with an associated error vector that satisfies the predetermined criterion.

Example 90 is the method of any one of examples 87 to 89, wherein determining the first movement vector includes determining the first movement vector based on whether the planned/expected movement includes as least one translational motion.

Example 91 is the method of any of examples 87 to 90, wherein the localization algorithm includes a simultaneous localization and mapping (SLAM)-based algorithm.

Example 92 is the method of any of examples 87 to 91, wherein the method further includes determining the mitigation strategy based on whether a Euclidian reference distance satisfies a predetermined criterion, wherein the Euclidian reference distance is defined by the first movement vector.

Example 93 is the method of any of examples 87 to 92, wherein the error vector includes a normalized error vector magnitude.

Example 94 is the method of any of examples 87 to 93, wherein the error vector includes a normalized error vector magnitude expressed as a percentage of a magnitude the first movement vector.

Example 95 is an apparatus for navigating a robot, the apparatus including a means for obtaining an occupancy grid associated with an environment around the robot, wherein the occupancy grid includes grid points of potential destinations for the robot. The apparatus also includes a means for determining, for each grid point of the grid points of potential destinations, a weight for the grid point based on a distance to the grid point from a predefined reference point and based on a directional deviation to the grid point, where the directional deviation includes an angular difference between a current heading of the robot and an angular direction from the reference point toward the grid point. The apparatus also includes a means for selecting, based on the weight, a target point from among the grid points. The apparatus also includes a means for generating a movement instruction associated with moving the robot toward the target point.

Example 96 is the apparatus of example 95, wherein the apparatus further includes a means for determining the distance based on a travel path to the grid point from a current position of the robot.

Example 97 is the apparatus of example 96, wherein the apparatus further includes a means for determining the travel path based on an occupancy characterization (e.g., traversable, occupied (non-traversable), unknown occupancy/unexplored, etc.) associated with each grid point in the occupancy grid along the travel path.

Example 98 is the apparatus of any one of examples 95 to 97, wherein the weight is based on a comparison of the distance to a predefined distance criterion.

Example 99 is the apparatus of example 98, wherein the predefined distance criterion is based on a physical dimension (e.g., radius) of the robot and/or a maximum scan range of a sensor for scanning the environment.

Example 100 is the apparatus of either of examples 98 or 99, wherein the apparatus further includes a means for determining the weight based on a first weighting factor associated with the distance and based on a second weighting factor associated with the directional deviation, wherein the second weighting factor is based on the comparison of the distance to the predefined distance criterion (e.g., the larger the distance to the grid point, the less the directional weighting).

Example 101 is the apparatus of any one of examples 95 to 100, wherein the apparatus further includes a means for including a grid point in the grid points of potential destinations based on whether the grid point is a predefined distance to a boundary defined by unexplored points in the occupancy grid in relation to explored points in the occupancy grid.

Example 102 is the apparatus of any one of examples 95 to 101, wherein the apparatus further includes a means for including a grid point in the grid points of potential destinations based on whether the grid point is a predefined distance to an occupied point in the occupancy grid.

Example 103 is the apparatus of example 102, wherein the occupied point represents non-traversable space in the occupancy grid.

Example 104 is the apparatus of any one of examples 95 to 103, wherein the apparatus further includes a means for determining the weight for each grid point based on whether the grid point is reachable by the robot.

Example 105 is the apparatus of any one of examples 95 to 104, wherein the reference point includes an actual position of the robot, an estimated position of the robot, or a planned position of the robot within the occupancy grid.

Example 106 is the apparatus of any one of examples 95 to 105, wherein the occupancy grid is associated with a first resolution defined by a dimension of the grid points, wherein the apparatus further includes a means for aligning a current location of the robot to a sampling point of sensor data indicative of the environment. The apparatus further includes a means for resampling the occupancy grid into a coarse occupancy grid associated with a second resolution defined by a second dimension of resampled grid points, wherein the second dimension is larger than the first dimension.

Example 107 is the apparatus of example 106, wherein the apparatus further includes a means for determining a travel path toward at least one of the potential destinations based on an occupancy characterization (e.g., traversable, occupied (not traversable), unknown occupancy/unexplored, etc.) associated with each resampled grid point in the coarse occupancy grid along the travel path.

Example 108 is the apparatus of example 107, wherein the apparatus further includes a means for determining the travel path based on a raytracing from a current position of the robot within the coarse occupancy grid.

Example 109 is the apparatus of any one of examples 95 to 108, wherein the apparatus further includes a means for providing, if a next waypoint along the travel path from a current position of the robot has a non-traversable occupancy characterization, a reverse instruction to the robot, wherein the reverse instruction indicates that the robot is to reverse along a previously traveled path used to arrive at the current position.

Example 110 is the apparatus of example 109, wherein the reverse instruction indicates that the robot is to reverse along the traveled path without regard to an occupancy characterization of the grid points in the occupancy grid that are along the traveled path.

Example 111 is the apparatus of either one of examples 109 to 110, wherein the apparatus further includes a means for decreasing, based on the reverse instruction, the weight of the grid point associated with the least one of the potential destinations.

Example 112 is the apparatus of either one of examples 110 to 111, wherein the apparatus further includes a means for receiving an updated set of sensor data at a location along the previously traveled path. The apparatus further includes a means for providing, based on whether the updated set of sensor data satisfies a predetermined safety criterion, an end-reverse instruction to the robot, wherein the end-reverse instruction indicates that the robot is to stop reversing along the previously traveled path.

Example 113 is the apparatus of example 112, wherein the predetermined safety criterion includes an indication that in the occupancy grid there is sufficient unoccupied space around the robot to navigate.

Example 114 is the apparatus of any one of examples 95 to 113, the apparatus further includes a means for storing (e.g., in a memory) at least one of the occupancy grid, the grid points of potential destinations, the weight, the directional deviation, the angular difference, the current heading, and/or the angular direction.

Example 115 is the apparatus of any one of examples 95 to 114, wherein the means for obtaining the occupancy grid includes a means for determining the occupancy grid based on a set of sensor data indicative of the environment around the robot.

Example 116 is the apparatus of example 115, wherein the set of sensor data includes a point cloud of distance measurements/vectors.

Example 117 is the apparatus of example 115, wherein the set of sensor data includes a point cloud of distance measurements from a light detection and ranging sensor.

Example 118 is the apparatus of any one of examples 95 to 117, the apparatus further including a means for receiving from a sensor (e.g., a LiDAR system, a camera system, etc.) the set of sensor data.

Example 119 is an apparatus for localization of a robot, the apparatus including a means for obtaining an expected position of the robot in relation to a prior position of the robot within the environment. The apparatus also includes a means for obtaining prior scan data of the environment at the prior position and a previous key point within the prior scan data. The apparatus also includes a means for translating, based on a difference between the prior position and the expected position, the prior scan data into transformed scan data. The apparatus also includes a means for obtaining current scan data of the environment at a current position of the robot. The apparatus also includes a means for combining the current scan data with the transformed scan data as combined scan data. The apparatus also includes a means for identifying an observed key point based on the combined scan data. The apparatus also includes a means for determining a correlation between the observed key point and the previous key point. The apparatus also includes a means for determining an estimated actual position of the robot based on the correlation and the expected position.

Example 120 is the apparatus of example 119, wherein the apparatus includes a means for determining the expected position based on an odometry change from the prior position to the current position.

Example 121 is the apparatus of either one of examples 119 or 120, wherein the apparatus further includes a means for determining the expected position based on a planned trajectory of the robot with respect to the prior position.

Example 122 is the apparatus of any one of examples 119 to 121, wherein the prior scan data includes a point cloud of points, wherein the previous key point within the prior scan data includes one or more of the points of the point cloud.

Example 123 is the apparatus of any one of examples 119 to 122, wherein the combined scan data includes a combined point cloud of combined points, wherein the observed key point within the combined scan data includes one or more of the combined points of the combined point cloud.

Example 124 is the apparatus of any one of examples 119 to 123, wherein the apparatus includes a means for adding an injected noise pattern to the prior scan data, wherein the injected noise pattern defines a simulated key point in the prior scan data.

Example 125 is the apparatus of example 124, wherein the apparatus includes a means for adding the injected noise pattern in a region of the prior scan data that positionally overlaps with the current scan data.

Example 126 is the apparatus of any one of examples 119 to 125, wherein the means for translating the prior scan data into transformed scan data includes a means for translating, based on the difference between the prior position and the expected position, coordinate points of the prior scan data that are based on the prior position into new coordinate points of the transformed scan data that are based on the expected position.

Example 127 is the apparatus of any one of examples 119 to 126, wherein the apparatus includes a means for obtaining a plurality of prior scan data sets, wherein each set of the prior scan data sets is at one of a plurality of prior positions of the robot, wherein one of the prior scan data sets includes the prior scan data and one of the plurality of prior positions includes the prior position.

Example 128 is the apparatus of any one of examples 119 to 127, wherein the apparatus further includes a means for identifying a plurality of previous key points at the prior position, wherein the previous key point includes one of the plurality of previous key points, wherein the apparatus further includes a means for identifying a plurality of observed key points based on the combined scan data wherein the observed key point is one of the plurality of observed key points, wherein the apparatus further includes a means for determining the correlation between the observed key points and the previous key points.

Example 129 is the apparatus of any one of examples 119 to 128, wherein the apparatus further includes a means for determining the correlation based on a directional uncertainty of the previous key point and/or the observed key point.

Example 130 is the apparatus of any one of examples 119 to 129, wherein the prior scan data and/or current scan data include a point cloud of distance measurements/vectors, wherein the previous key point and/or observed key point includes a point or group of points in the point cloud.

Example 131 is the apparatus of any one of examples 119 to 130, wherein the prior scan data and/or current scan data include image data, wherein the previous key point and/or observed key point includes a point extracted from the image data.

Example 132 is the apparatus of any one of examples 119 to 131, wherein the apparatus further includes a means for determining the correlation between the observed key point and the previous key point based on the combined scan data.

Example 133 is the apparatus of any one of examples 119 to 132, wherein the apparatus further includes a means for determining the correlation between the observed key point and the previous key point based on a simultaneous localization and mapping (SLAM) equation solver algorithm that uses the combined scan data as an input to the SLAM equation solver.

Example 134 is an apparatus for localization and control of a robot, the apparatus including a means for determining a first movement vector based on an odometry change from a prior position of the robot or based on a planned/expected movement of the robot from the prior position. The apparatus also includes a means for determining a second movement vector based on a localization algorithm with respect to a current sensor scan in relation to the prior position. The apparatus also includes a means for determining an error vector between the first movement vector and the second movement vector. The apparatus also includes a means for determining a mitigation strategy based on based on whether the error vector satisfies a predetermined error criterion. The apparatus also includes a means for generating an instruction to control the robot based on the mitigation strategy.

Example 135 is the apparatus of example 134, wherein the mitigation strategy includes a reset of the localization algorithm.

Example 136 is the apparatus of either of examples 134 or 135, wherein the mitigation strategy includes a return of the robot to the prior position or a previous position with an associated error vector that satisfies the predetermined criterion.

Example 137 is the apparatus of any one of examples 134 to 136, wherein means for determining the first movement vector includes a means for determining the first movement vector based on whether the planned/expected movement includes as least one translational motion.

Example 138 is the apparatus of any of examples 134 to 137, wherein the localization algorithm includes a simultaneous localization and mapping (SLAM)-based algorithm.

Example 139 is the apparatus of any of examples 134 to 138, wherein the apparatus further includes a means for determining the mitigation strategy based on whether a Euclidian reference distance satisfies a predetermined criterion, wherein the Euclidian reference distance is defined by the first movement vector.

Example 140 is the apparatus of any of examples 134 to 139, wherein the error vector includes a normalized error vector magnitude.

Example 141 is the apparatus of any of examples 134 to 140, wherein the error vector includes a normalized error vector magnitude expressed as a percentage of a magnitude the first movement vector.

Example 142 is a non-transitory computer readable medium that includes instructions which, if executed, cause one or more processors to obtain an occupancy grid associated with an environment around a robot, wherein the occupancy grid includes grid points of potential destinations for the robot. The instructions also cause the one or more processors to determine, for each grid point of the grid points of potential destinations, a weight for the grid point based on a distance to the grid point from a predefined reference point and based on a directional deviation to the grid point, where the directional deviation includes an angular difference between a current heading of the robot and an angular direction from the reference point toward the grid point. The instructions also cause the one or more processors to select, based on the weight, a target point from among the grid points. The instructions also cause the one or more processors to generate a movement instruction associated with moving the robot toward the target point.

Example 143 is the non-transitory computer readable medium of example 142, wherein the instructions also cause the one or more processors to determine the distance based on a travel path to the grid point from a current position of the robot.

Example 144 is the non-transitory computer readable medium of example 143, wherein the instructions also cause the one or more processors to determine the travel path based on an occupancy characterization (e.g., traversable, occupied (non-traversable), unknown occupancy/unexplored, etc.) associated with each grid point in the occupancy grid along the travel path.

Example 145 is the non-transitory computer readable medium of any one of examples 142 to 144, wherein the weight is based on a comparison of the distance to a predefined distance criterion.

Example 146 is the non-transitory computer readable medium of example 145, wherein the predefined distance criterion is based on a physical dimension (e.g., radius) of the robot and/or a maximum scan range of a sensor for scanning the environment.

Example 147 is the non-transitory computer readable medium of either of examples 145 or 146, wherein the instructions also cause the one or more processors to determine the weight based on a first weighting factor associated with the distance and based on a second weighting factor associated with the directional deviation, wherein the second weighting factor is based on the comparison of the distance to the predefined distance criterion (e.g., the larger the distance to the grid point, the less the directional weighting).

Example 148 is the non-transitory computer readable medium of any one of examples 142 to 147, wherein the instructions also cause the one or more processors to include a grid point in the grid points of potential destinations based on whether the grid point is a predefined distance to a boundary defined by unexplored points in the occupancy grid in relation to explored points in the occupancy grid.

Example 149 is the non-transitory computer readable medium of any one of examples 142 to 148, wherein the instructions also cause the one or more processors to include a grid point in the grid points of potential destinations based on whether the grid point is a predefined distance to an occupied point in the occupancy grid.

Example 150 is the non-transitory computer readable medium of example 149, wherein the occupied point represents non-traversable space in the occupancy grid.

Example 151 is the non-transitory computer readable medium of any one of examples 142 to 150, wherein the instructions also cause the one or more processors to determine the weight for each grid point based on whether the grid point is reachable by the robot.

Example 152 is the non-transitory computer readable medium of any one of examples 142 to 151, wherein the reference point includes an actual position of the robot, an estimated position of the robot, or a planned position of the robot within the occupancy grid.

Example 153 is the non-transitory computer readable medium of any one of examples 142 to 152, wherein the occupancy grid is associated with a first resolution defined by a dimension of the grid points, wherein the instructions also cause the one or more processors to align a current location of the robot to a sampling point of sensor data indicative of the environment. The instructions also cause the one or more processors to resample the occupancy grid into a coarse occupancy grid associated with a second resolution defined by a second dimension of resampled grid points, wherein the second dimension is larger than the first dimension.

Example 154 is the non-transitory computer readable medium of example 153, wherein the instructions also cause the one or more processors to determine a travel path toward at least one of the potential destinations based on an occupancy characterization (e.g., traversable, occupied (not traversable), unknown occupancy/unexplored, etc.) associated with each resampled grid point in the coarse occupancy grid along the travel path.

Example 155 is the non-transitory computer readable medium of example 154, wherein the instructions also cause the one or more processors to determine the travel path based on a raytracing from a current position of the robot within the coarse occupancy grid.

Example 156 is the non-transitory computer readable medium of any one of examples 142 to 155, wherein the instructions also cause the one or more processors to, if a next waypoint along the travel path from a current position of the robot has a non-traversable occupancy characterization, provide a reverse instruction to the robot, wherein the reverse instruction indicates that the robot is to reverse along a previously traveled path used to arrive at the current position.

Example 157 is the non-transitory computer readable medium of example 156, wherein the reverse instruction indicates that the robot is to reverse along the traveled path without regard to an occupancy characterization of the grid points in the occupancy grid that are along the traveled path.

Example 158 is the non-transitory computer readable medium of either one of examples 156 to 157, wherein the instructions also cause the one or more processors to, based on the reverse instruction, decrease the weight of the grid point associated with the least one of the potential destinations.

Example 159 is the non-transitory computer readable medium of either one of examples 157 to 158, wherein the instructions also cause the one or more processors to receive an updated set of sensor data at a location along the previously traveled path. The instructions also cause the one or more processors to provide, based on whether the updated set of sensor data satisfies a predetermined safety criterion, an end-reverse instruction to the robot, wherein the end-reverse instruction indicates that the robot is to stop reversing along the previously traveled path.

Example 160 is the non-transitory computer readable medium of example 159, wherein the predetermined safety criterion includes an indication that in the occupancy grid there is sufficient unoccupied space around the robot to navigate.

Example 161 is the non-transitory computer readable medium of any one of examples 142 to 160, wherein the instructions also cause the one or more processors to store (e.g., in a memory) at least one of the occupancy grid, the grid points of potential destinations, the weight, the directional deviation, the angular difference, the current heading, and/or the angular direction.

Example 162 is the non-transitory computer readable medium of any one of examples 142 to 161, wherein the instructions that cause the one or more processors to obtain the occupancy grid include that the instructions cause the one or more processors to determine the occupancy grid based on a set of sensor data indicative of the environment around the robot.

Example 163 is the non-transitory computer readable medium of example 162, wherein the set of sensor data includes a point cloud of distance measurements/vectors.

Example 164 is the non-transitory computer readable medium of example 162, wherein the set of sensor data includes a point cloud of distance measurements from a light detection and ranging sensor.

Example 165 is the non-transitory computer readable medium of any one of examples 142 to 164, wherein the instructions also cause the one or more processors to receive the set of sensor data from a sensor (e.g., a LiDAR system, a camera system, etc.).

Example 166 is a non-transitory computer readable medium that includes instructions which, if executed, cause one or more processors to obtain an expected position of the robot in relation to a prior position of the robot within the environment. The instructions also cause the one or more processors to obtain prior scan data of the environment at the prior position and a previous key point within the prior scan data. The instructions also cause the one or more processors to translate, based on a difference between the prior position and the expected position, the prior scan data into transformed scan data. The instructions also cause the one or more processors to obtain current scan data of the environment at a current position of the robot. The instructions also cause the one or more processors to combine the current scan data with the transformed scan data as combined scan data. The instructions also cause the one or more processors to identify an observed key point based on the combined scan data. The instructions also cause the one or more processors to determine a correlation between the observed key point and the previous key point. The instructions also cause the one or more processors to determine an estimated actual position of the robot based on the correlation and the expected position.

Example 167 is the non-transitory computer readable medium of example 166, wherein the instructions also cause the one or more processors to determine the expected position based on an odometry change from the prior position to the current position.

Example 168 is the non-transitory computer readable medium of either one of examples 166 or 167, wherein the instructions also cause the one or more processors to determine the expected position based on a planned trajectory of the robot with respect to the prior position.

Example 169 is the non-transitory computer readable medium of any one of examples 166 to 168, wherein the prior scan data includes a point cloud of points, wherein the previous key point within the prior scan data includes one or more of the points of the point cloud.

Example 170 is the non-transitory computer readable medium of any one of examples 166 to 169, wherein the combined scan data comprises a combined point cloud of combined points, wherein the observed key point within the combined scan data includes one or more of the combined points of the includes point cloud.

Example 171 is the non-transitory computer readable medium of any one of examples 166 to 170, wherein the instructions also cause the one or more processors to add an injected noise pattern to the prior scan data, wherein the injected noise pattern defines a simulated key point in the prior scan data.

Example 172 is the non-transitory computer readable medium of example 171, wherein the instructions also cause the one or more processors to add the injected noise pattern in a region of the prior scan data that positionally overlaps with the current scan data.

Example 173 is the non-transitory computer readable medium of any one of examples 166 to 172, wherein the instructions that cause the one or more processors to translate the prior scan data into transformed scan data includes instructions that cause the one or more processors to, based on the difference between the prior position and the expected position, translate coordinate points of the prior scan data that are based on the prior position into new coordinate points of the transformed scan data that are based on the expected position.

Example 174 is the non-transitory computer readable medium of any one of examples 166 to 173, wherein the instructions also cause the one or more processors to obtain a plurality of prior scan data sets, wherein each set of the prior scan data sets is at one of a plurality of prior positions of the robot, wherein one of the prior scan data sets includes the prior scan data and one of the plurality of prior positions includes the prior position.

Example 175 is the non-transitory computer readable medium of any one of examples 166 to 174, wherein the instructions also cause the one or more processors to identify a plurality of previous key points at the prior position, wherein the previous key point includes one of the plurality of previous key points, wherein the instructions also cause the one or more processors to identify a plurality of observed key points based on the combined scan data wherein the observed key point is one of the plurality of observed key points, wherein the instructions also cause the one or more processors to determine the correlation between the observed key points and the previous key points.

Example 176 is the non-transitory computer readable medium of any one of examples 166 to 175, wherein the instructions also cause the one or more processors to determine the correlation based on a directional uncertainty of the previous key point and/or the observed key point.

Example 177 is the non-transitory computer readable medium of any one of examples 166 to 176, wherein the prior scan data and/or current scan data include a point cloud of distance measurements/vectors, wherein the previous key point and/or observed key point includes a point or group of points in the point cloud.

Example 178 is the non-transitory computer readable medium of any one of examples 166 to 177, wherein the prior scan data and/or current scan data include image data, wherein the previous key point and/or observed key point includes a point extracted from the image data.

Example 179 is the non-transitory computer readable medium of any one of examples 166 to 178, wherein the instructions also cause the one or more processors to determine the correlation between the observed key point and the previous key point based on the combined scan data.

Example 180 is the non-transitory computer readable medium of any one of examples 166 to 179, wherein the instructions also cause the one or more processors to determine the correlation between the observed key point and the previous key point based on a simultaneous localization and mapping (SLAM) equation solver algorithm that uses the combined scan data as an input to the SLAM equation solver.

Example 181 is a non-transitory computer readable medium that includes instructions which, if executed, cause one or more processors to determine a first movement vector based on an odometry change from a prior position of the robot or based on a planned/expected movement of the robot from the prior position. The instructions also cause the one or more processors to determine a second movement vector based on a localization algorithm with respect to a current sensor scan in relation to the prior position. The instructions also cause the one or more processors to determine an error vector between the first movement vector and the second movement vector. The instructions also cause the one or more processors to determine a mitigation strategy based on based on whether the error vector satisfies a predetermined error criterion. The instructions also cause the one or more processors to generate an instruction to control the robot based on the mitigation strategy.

Example 182 is the non-transitory computer readable medium of example 181, wherein the mitigation strategy includes a reset of the localization algorithm.

Example 183 is the non-transitory computer readable medium of either of examples 181 or 182, wherein the mitigation strategy includes a return of the robot to the prior position or a previous position with an associated error vector that satisfies the predetermined criterion.

Example 184 is the non-transitory computer readable medium of any of examples 181 to 183, wherein the instructions that determine the first movement vector further includes instructions that determine the first movement vector based on whether the planned/expected movement includes as least one translational motion.

Example 185 is the non-transitory computer readable medium of any of examples 181 to 184, wherein the localization algorithm includes a simultaneous localization and mapping (SLAM)-based algorithm.

Example 186 is the non-transitory computer readable medium of any of examples 181 to 185, wherein the instructions cause the one or more processors to determine the mitigation strategy based on whether a Euclidian reference distance satisfies a predetermined criterion, wherein the Euclidian reference distance is defined by the first movement vector.

Example 187 is the non-transitory computer readable medium of any of examples 181 to 186, wherein the error vector includes a normalized error vector magnitude.

Example 188 is the non-transitory computer readable medium of any of examples 181 to 187, wherein the error vector includes a normalized error vector magnitude expressed as a percentage of a magnitude the first movement vector.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

Claimed is:

1. A device comprising a processor configured to:
obtain an occupancy grid associated with an environment around a robot, wherein the occupancy grid comprises grid points of potential destinations for the robot;
determine, for each grid point of the grid points of potential destinations, a weight for the grid point based on a distance to the grid point from a predefined reference point and based on a directional deviation to the grid point, where the directional deviation comprises an angular difference between a current heading of the robot and an angular direction from the predefined reference point toward the grid point;
select, based on the weight, a target point from among the grid points; and
generate a movement instruction associated with moving the robot toward the target point.

2. The device of claim 1, wherein the processor is further configured to determine the distance based on a travel path to the grid point from a current position of the robot.

3. The device of claim 2, wherein the processor is further configured to determine the travel path based on an occupancy characterization associated with each grid point in the occupancy grid along the travel path.

4. The device of claim 1, wherein the weight is based on a comparison of the distance to a predefined distance criterion, wherein the predefined distance criterion is based on a physical dimension of the robot and/or a maximum scan range of a sensor for scanning the environment.

5. The device of claim 4, wherein the processor is further configured to determine the weight based on a first weighting factor associated with the distance and based on a second weighting factor associated with the directional deviation, wherein the second weighting factor is based on the comparison of the distance to the predefined distance criterion.

6. The device of claim 1, wherein the processor is further configured to include a grid point in the grid points of potential destinations based on whether the grid point is a predefined distance to a boundary defined by unexplored points in the occupancy grid in relation to explored points in the occupancy grid or based on whether the grid point is a predefined distance to an occupied point in the occupancy grid.

7. The device of claim 1, wherein the processor further configured to determine the weight for each grid point based on whether the grid point is reachable by the robot.

8. The device of claim 1, wherein the occupancy grid is associated with a first resolution defined by a first dimension of the grid points, wherein the processor is further configured to:
align a current location of the robot to a sampling point of sensor data indicative of the environment; and
resample the occupancy grid into a coarse occupancy grid associated with a second resolution defined by a second dimension of resampled grid points, wherein the second dimension is larger than the first dimension.

9. The device of claim 2, wherein the processor is further configured to, if a next waypoint along the travel path from a current position of the robot has a non-traversable occupancy characterization, provide a reverse instruction to the robot, wherein the reverse instruction indicates that the robot is to reverse along a previously traveled path used to arrive at the current position, wherein the reverse instruction indicates that the robot is to reverse along the traveled path without regard to an occupancy characterization of the grid points in the occupancy grid that are along the previously traveled path.

10. A device comprising a processor configured to:
obtain an expected position of a robot in relation to a prior position of the robot within an environment;
obtain prior scan data of the environment at the prior position and a previous key point within the prior scan data;
translate, based on a difference between the prior position and the expected position, the prior scan data into transformed scan data;
obtain current scan data of the environment at a current position of the robot;
combine the current scan data with the transformed scan data as combined scan data;
identify an observed key point based on the combined scan data;
determine a correlation between the observed key point and the previous key point; and
determine an estimated actual position of the robot based on the correlation and the expected position.

11. The device of claim 10, wherein the processor is configured to determine the expected position based on an odometry change from the prior position to the current position.

12. The device of claim 10, wherein the processor is configured to determine the expected position based on a planned trajectory of the robot with respect to the prior position.

13. The device of claim 10, wherein the processor is configured to add an injected noise pattern to the prior scan data in a region of the prior scan data that positionally overlaps with the current scan data.

14. The device of claim 10, wherein the processor configured to translate the prior scan data into transformed scan data comprises the processor configured to, based on the difference between the prior position and the expected position, translate coordinate points of the prior scan data that are based on the prior position into new coordinate points of the transformed scan data that are based on the expected position.

15. The device of claim 10, wherein the processor is configured to obtain a plurality of prior scan data sets, wherein each set of the prior scan data sets is at one of a plurality of prior positions of the robot, wherein one of the prior scan data sets comprises the prior scan data and one of the plurality of prior positions comprises the prior position.

16. The device of claim 10, wherein the processor is further configured to identify a plurality of previous key points at the prior position, wherein the previous key point comprises one of the plurality of previous key points, wherein the processor is further configured to identify a plurality of observed key points based on the combined scan data wherein the observed key point is one of the plurality of observed key points, wherein the processor is further configured to determine the correlation between the observed key points and the previous key points.

17. The device of claim 10, wherein the processor is configured to determine the correlation between the observed key point and the previous key point based on the combined scan data.

18. The device of claim 10, wherein the processor is configured to determine the correlation between the observed key point and the previous key point based on a simultaneous localization and mapping (SLAM) equation solver algorithm that uses the combined scan data as an input to the SLAM equation solver.

19. A device comprising a processor configured to:
determine a first movement vector based on an odometry change from a prior position of a robot or based on a planned/expected movement of the robot from the prior position;
determine a second movement vector based on a localization algorithm with respect to a current sensor scan in relation to the prior position;
determine an error vector between the first movement vector and the second movement vector;
determine a mitigation strategy based on based on whether the error vector satisfies a predetermined error criterion; and
generate an instruction to control the robot based on the mitigation strategy.

20. The device of claim 19, wherein the mitigation strategy comprises:
a reset of the localization algorithm; or
a return of the robot to the prior position or a previous position with an associated error vector that satisfies the predetermined error criterion.
